(19) United States
(12) Patent Application Publication
(10) Pub. No.: US 2024/0353621 A1
(43) Pub. Date: Oct. 24, 2024

(54) LOW LOSS AND HIGH RETURN LOSS COUPLING BETWEEN SOLID-CORE FIBER AND HOLLOW-CORE FIBER

(71) Applicant: OFS Fitel, LLC, Norcross, GA (US)

(72) Inventor: Jeffrey W. Nicholson, Warren, NJ (US)

(73) Assignee: OFS Fitel LLC, Norcross, GA (US)

(21) Appl. No.: 18/377,778

(22) Filed: Oct. 7, 2023

Related U.S. Application Data
(60) Provisional application No. 63/461,362, filed on Apr. 24, 2023.

(51) Int. Cl. G02B 6/26; G02B 6/02; G02B 6/14

(52) U.S. Cl. CPC G02B 6/262; G02B 6/02038; G02B 6/02304; G02B 6/14

(57) ABSTRACT

The present disclosure provides systems and methods for optically coupling a solid-core fiber (SCF) with a hollow-core fiber (HCF). Briefly described, one embodiment of the system comprises a graded-index (GRIN) fiber and a hollow fiber (HF) that optically couple the SCF with the HCF. The combination of the GRIN with the HF permits mode matching between the SCF and the HCF, while concurrently increasing return loss from the HCF to the SCF.

### CROSS REFERENCE TO RELATED APPLICATIONS

This application claims the benefit of U.S. provisional patent application Ser. No. 63/461,362, filed Apr. 24, 2023, having the title “low loss and high return loss coupling between solid-core and hollow-core fiber,” with first-named inventor Jeffrey W. Nicholson, which is incorporated herein by reference in its entirety.

### BACKGROUND

### Field of the Disclosure

The present disclosure relates generally to optical interconnects and, more particularly, to optical fiber interconnections.

### Description of Related Art

Signal transmission from one length of optical fiber to another length of optical fiber requires optical coupling between the two lengths of optical fibers. Usually, fusion splices or mechanical connectors are used to optically couple the fibers so that a continuous optical path is provided between the optical fibers. Issues that arise in the transmission path between the two fibers are sometimes exacerbated when optically coupling two different types of optical fibers.

### SUMMARY

The present disclosure provides systems and methods for optically coupling a solid-core fiber (SCF) with a hollow-core fiber (HCF). Briefly described, one embodiment of the system comprises a graded-index (GRIN) fiber and a hollow fiber (HF) that optically couples the SCF with the HCF. The combination of the GRIN with the HF permits mode matching between the SCF and the HCF, while concurrently increasing return loss from the HCF to the SCF.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of a connector system 100 between an ultra-large area (ULA) fiber 130 and a hollow-core fiber (HCF) 160.

FIG. 2 is a diagram 200 illustrating a graded-index (GRIN) fiber 220 (or GRIN lens) connected between a solid-core fiber (SCF) 210 and a HCF 230.

FIG. 3 is a graph 300 showing beam propagation 310 in a GRIN lens with position (in millimeters (mm)) along a horizontal axis (hereafter designated as “X-axis” or simply “X”) and mode-field diameter (MFD) (in micrometers (μm) or microns) along a vertical axis (hereafter designated as “Y-axis” or simply “Y”) in accordance with one embodiment of the invention.

FIG. 4 is a diagram showing one embodiment of a SCF-to-HCF coupling system 400 using a combination of a coreless fiber 415, a GRIN fiber 220, and a hollow fiber (HF) 425.

FIG. 5 is a graph 500 showing MFD (along Y) as a function of fiber position (along X) as an optical beam propagates forward and backward in the coreless fiber region 515, the GRIN fiber region 520, and the HF region 525 in one embodiment of a SCF-to-HCF connector system.

FIG. 6 is a graph 600 showing MFD (along Y) as a function of fiber position (along X) as an optical beam propagates forward and backward in the coreless fiber region 615, the GRIN fiber region 620, and the HF region 625 in another embodiment of a SCF-to-HCF connector system.

FIG. 7 is a graph 700 showing output fiber coupling (along Y) as a function 710 of HF position (along X) in accordance with one embodiment of the invention.

FIG. 8 is a graph 800 showing MFD (along Y) as a function of fiber position (along X) as an optical beam propagates forward and backward in the coreless fiber region 815, the GRIN fiber region 820, and the HF region 825 in another embodiment of a SCF-to-HCF connector system.

FIG. 9 is a graph 900 showing MFD (along Y) as a function of fiber position (along X) as an optical beam propagates forward and backward in the coreless fiber region 915, the GRIN fiber region 920, and the HF region 925 in another embodiment of a SCF-to-HCF connector system.

FIG. 10 is a graph 1000 comparing a first GRIN profile 1010 with a second GRIN profile 1020 with a different index difference (Δn), with Δn along Y and MFD radius along X in accordance with one embodiment of the invention.

FIG. 11 is a graph 1100 plotting GRIN radius where Δn=0 (along Y) as a function of GRIN index at MFD radius (r) of 0 in accordance with one embodiment of the invention.

FIG. 12 is a graph 1200 plotting lengths (in units of mm) of a coreless fiber 1210, a GRIN fiber 1220, and a HF 1230 along Y as a function of a GRIN parameter (in units of inverse meters (1/m)) along X in accordance with one embodiment of the invention.

FIG. 13 is a graph 1300 plotting both output coupling loss 1310 (in units of decibels (dB)) and return coupling loss 1320 (dB) along Y, both as a function of the GRIN parameter (1/m) along X in accordance with one embodiment of the invention.

FIG. 14 is a graph 1400 plotting a maximum MFD (μm) in the GRIN fiber along Y as a function of the GRIN (1/m) parameter along X in accordance with one embodiment of the invention.

FIG. 15 is a graph 1500 plotting lengths (mm) of a coreless fiber 1510, a GRIN fiber 1520, and a HF 1530 along Y as a function of a radius (μm) where GRIN Δn=0 along X in accordance with one embodiment of the invention.

FIG. 16 is a graph 1600 plotting both output coupling loss 1610 (dB) and return coupling loss 1620 (dB) along Y, both as a function of radius (μm) where the GRIN Δn=0 along X in accordance with one embodiment of the invention.

FIG. 17 is a graph 1700 plotting maximum MFD (μm) in a GRIN fiber 1710 along Y as a function of radius (μm) where the GRIN Δn=0 along X in accordance with one embodiment of the invention.

FIG. 18 is a graph 1800 plotting radius (μm) where the GRIN Δn=0 along Y as a function of GRIN parameter (1/m) along X in accordance with one embodiment of the invention.

FIG. 19 is a graph 1900 plotting lengths (mm) of a coreless fiber 1910, a GRIN fiber 1920, and a HF 1930 along Y as a function of a GRIN parameter (1/m) along X in accordance with one embodiment of the invention.

FIG. 20 is a graph 2000 plotting both output coupling loss 2010 (dB) and return coupling loss 2020 (dB) along Y, both as a function of the GRIN parameter (1/m) along X in accordance with one embodiment of the invention.

FIG. 21 is a graph 2100 plotting both output coupling loss 2110 (dB) and return coupling loss 2120 (dB) along Y, both as a function of the GRIN parameter (1/m) along X in accordance with one embodiment of the invention.

FIG. 22 is a graph 2200 plotting lengths (mm) of a coreless fiber 2210, a GRIN fiber 2220, and a HF 2230 along Y as a function of a GRIN parameter (1/m) along X in accordance with one embodiment of the invention.

FIG. 23 is a graph 2300 plotting both output coupling loss 2310 (dB) and return coupling loss 2320 (dB) along Y, both as a function of the GRIN parameter (1/m) along X in accordance with one embodiment of the invention.

FIG. 24 is a diagram showing another embodiment of a SCF-to-HCF connector system 2400 using a combination of a coreless a GRIN fiber 220 and a HF 2425.

FIG. 25 is a graph 2500 plotting both forward and backward beam-propagation behavior in the GRIN fiber region 2520 and the HF region 2525, with MFD (μm) along Y as a function of position (mm) along X in accordance with one embodiment of the invention.

FIG. 26 is a graph 2600 comparing two (2) GRIN propagation calculations with MFD (μm) along Y and position (mm) along X in accordance with one embodiment of the invention.

FIG. 27 is a graph 2700 showing behavior of MFD 2710 from an input of a GRIN fiber to an output of the GRIN fiber for a telecommunications (telecom) application, showing MFD (μm) along Y and position (mm) along X, in accordance with one embodiment of the invention.

FIG. 28 is a graph 2800 showing behavior of MFD 2810 from an input of a GRIN fiber to an output of a GRIN fiber for a laser application, showing MFD (μm) along Y and position (mm) along X, in accordance with one embodiment of the invention.

FIG. 29 is a graph 2900 showing output coupling loss (dB) for a system with a coreless fiber 2910 in comparison to a system without a coreless fiber 2920, with output coupling loss (dB) along Y and GRIN parameter (1/m) along X, in accordance with one embodiment of the invention.

FIG. 30 is a graph 3000 showing return loss (dB) for a system with a coreless fiber 3010 in comparison to a system without a coreless fiber 3020, with return loss (dB) along Y and GRIN parameter (1/m) along X, in accordance with one embodiment of the invention.

FIG. 31 is a diagram showing a telecom system 3100 with signal transmission from a SCF 3110 to a HCF 3120 to another SCF 3130 in accordance with one embodiment of the invention.

FIG. 32 is a graph 3200 showing behavior of MFD (μm) along Y as a function of position (mm) along X for a signal propagating backward in a telecom system in accordance with one embodiment of the invention.

FIG. 33 is a drawing 3300 showing coupling into a photonic band gap (PBG) HCF mode in accordance with one embodiment of the invention.

FIG. 34 is a drawing 3400 illustrating an optimized mode for coupling into a HCP in accordance with one embodiment of the invention.

FIG. 35 is a graph 3500 showing coupling loss (dB) along Y as a function of launch effective area (A_{eff}, in μm²) along X in accordance with one embodiment of the invention.

FIG. 36 is a table 3600 comparing MFD (μm), output coupling loss (dB), and return loss (dB) between a SMF, PBG-HCF (horizontal polarization), and PBG-HCF (vertical polarization) in accordance with one embodiment of the invention.

FIG. 37 is a drawing 3700 showing a sub-optimal mode for coupling to anti-resonant (AR) HCF in accordance with one embodiment of the invention.

FIG. 38 is a drawing 3800 showing an optimal mode for coupling into AR-HCF in accordance with one embodiment of the invention.

FIG. 39 is a table 3900 comparing MFD (μm), output coupling loss (dB), and return loss (dB) between a SMF, AR-HCF (horizontal polarization), and AR-HCF (vertical polarization) in accordance with one embodiment of the invention.

FIG. 40 is a diagram showing both forward and backward behavior of MFD (μm) for a very large mode area (VLMA) erbium (Er) doped fiber in a GRIN fiber region 4015, a HF region 4020, and a HCF region 4025 in accordance with one embodiment of the invention.

FIG. 41 is a diagram showing both forward and backward behavior of MFD (μm) for another VLMA Er-doped fiber in a GRIN fiber region 4115, a HF region 4120, and a HCF region 4125 in accordance with one embodiment of the invention.

FIG. 42 is a graph 4200 plotting length (mm) along Y as a function of GRIN parameter (1/m) along X for a coreless fiber 4210, a GRIN fiber 4220, and a HF 4230 in accordance with one embodiment of the invention.

FIG. 43 is a graph 4300 comparing output coupling loss 4310 with return loss 4320, with loss (dB) along Y and GRIN parameter (1/m) along X, in accordance with one embodiment of the invention.

FIG. 44 is a graph 4400 showing a measured refractive index profile 4410 for a GRIN fiber in accordance with one embodiment of the invention, with Δn along Y and radius (μm) along X.

FIG. 45 is a diagram 4500 showing both forward and backward behavior of MFD (μm) for the GRIN fiber of FIG. 44 in a GRIN fiber region 4115, a HF region 4120, and a HCF region 4125 in accordance with one embodiment of the invention.

FIG. 46 is a diagram 4600 showing variations in measured GRIN lengths 4610, in accordance with one embodiment of the invention, and a standard deviation (SD) curve 4620 fit to the measured GRIN lengths 4610.

FIG. 47 is graph 4700 showing sensitivity of output coupling loss (dB) as a function of SD of length error (μm) in accordance with one embodiment of the invention having a coreless fiber, showing minimum output coupling loss 4710, maximum output coupling loss 4720, and mean-plus-SD 4730 of the output coupling loss.

FIG. 48 is graph 4800 showing sensitivity of return loss (dB) as a function of SD of length error (μm) in accordance with one embodiment of the invention having a coreless fiber, showing minimum return loss 4810, maximum return loss 4820, and mean-plus-SD 4830 of the return loss.

FIG. 49 is graph 4900 showing sensitivity of output coupling loss (dB) as a function of SD of length error (μm) in accordance with one embodiment of the invention without a coreless fiber, showing minimum output coupling loss 4910, maximum output coupling loss 4920, and mean-plus-SD 4930 of the output coupling loss.

FIG. 50 is graph 5000 showing sensitivity of return loss (dB) as a function of SD of length error (μm) in accordance with one embodiment of the invention without a coreless fiber, showing minimum return loss 5010, maximum return loss 5020, and mean-plus-SD 5030 of the return loss.

FIG. 51 is a diagram showing a coupling system 5100 in which an anti-reflective coating 5140 is applied between a GRIN fiber 5120 and a HF 5125 in accordance with one embodiment of the invention.

FIG. 52 is a diagram showing a connector 5200 in accordance with one embodiment of the invention, which is capable of implementing a SMF-to-HCF connection.

FIG. 53 is a diagram showing one embodiment of a packaging system 5300 for the optical assembly for use with high power fiber lasers with a baseplate 5350 with a groove 5355 that holds a SCF 5310 and a HCF 5330, with the groove filled with thermal interface material to manage the temperature of the optical assembly during high-power laser operation.

### DETAILED DESCRIPTION OF THE EMBODIMENTS

Signal transmission from one length of optical fiber to another length of optical fiber requires optical coupling between the two lengths of optical fibers. Usually, fusion splices or mechanical connectors are used to optically couple the fibers so that a continuous optical path is provided between the optical fibers. Issues that arise in the transmission path between the two fibers are sometimes exacerbated when optically coupling two different types of optical fibers.

If one fiber is a solid-core fiber (SCF) and the other fiber is a hollow-core fiber (HCF), then reflectivity issues arise at a glass-air interface that exists between the SCF and the HCF, such as large (e.g., approximately 3.4 percent (˜3.4%) or approximately negative 14.7 decibel (−14.7 dB)) reflections back into the SCF. Many fiber-optic applications are sensitive to these types of reflections.

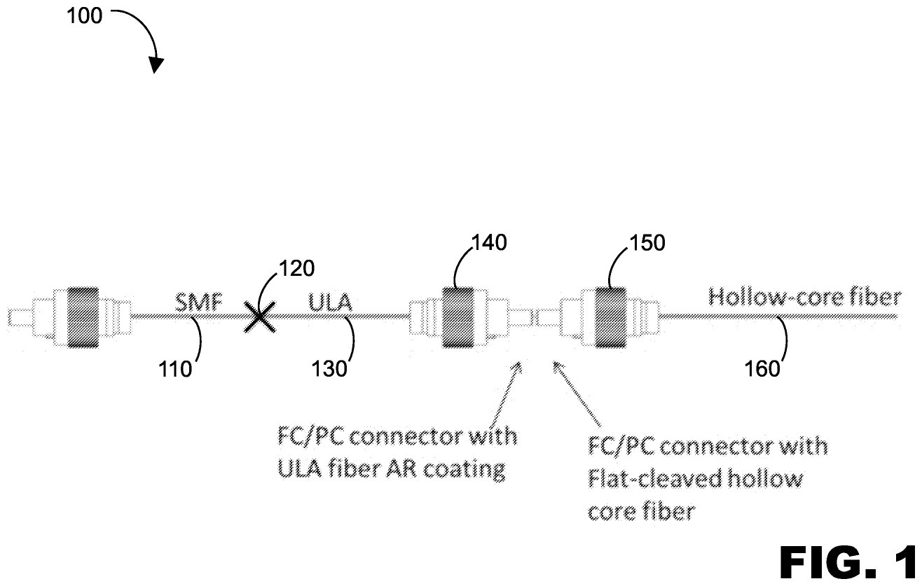

As shown in a connector system 100 of FIG. 1, some applications that utilize low-loss, high-return-loss coupling between a single-mode fiber (SMF) 110 and a HCF 160. In such a system, the SMF 110 (which is a SCF) is spliced 120 to an ultra-large-area (ULA) fiber 130, which is chosen to have the same mode-field diameter (MFD) as the HCF 160, thereby providing the lowest coupling loss into the HCF 160. In addition, a fiber-channel, physical-contact (FC/PC) connector 140 with a dielectric, antireflection coating is applied to the ULA fiber 130 to significantly increase the return loss. Because dielectric anti-reflective coatings cannot be fusion spliced, a matching HCF connector (such as a FC/PC connector 150) is fashioned for use with the HCF 160, thereby allowing the two FC/PC connectors 140, 150 to provide the optical connection between the ULA fiber 130 and the HCF 160. The two FC/PC connectors 140, 150 provides a coupling loss of ˜0.3 dB and a return loss of ˜30 dB to ˜40 dB. This type of system 100, unfortunately, requires mechanical connectors, such as the FC/PC connectors 140, 150 shown in FIG. 1.

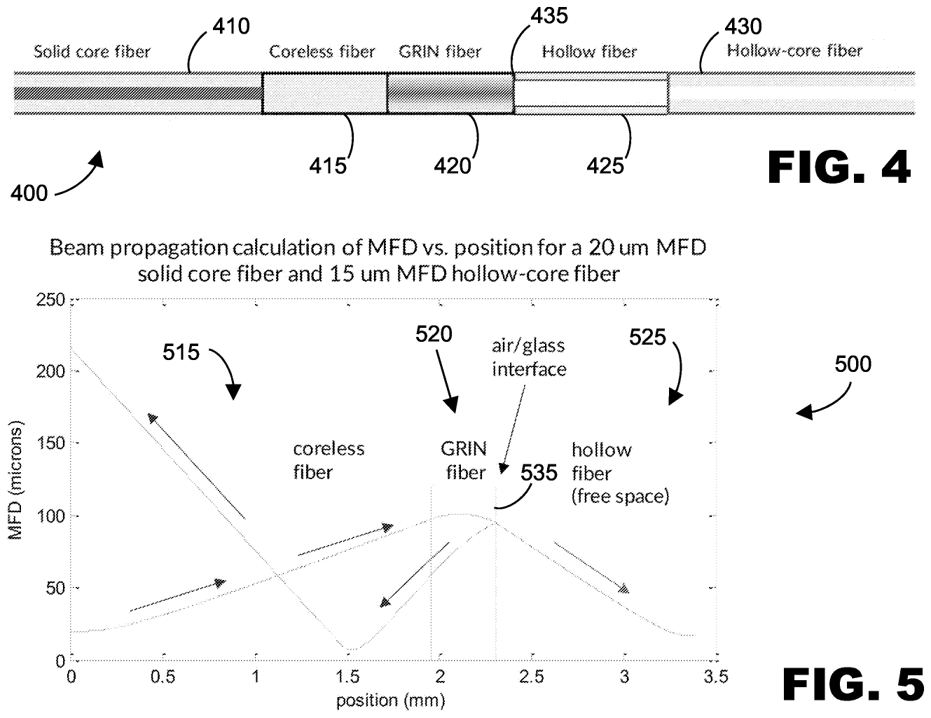

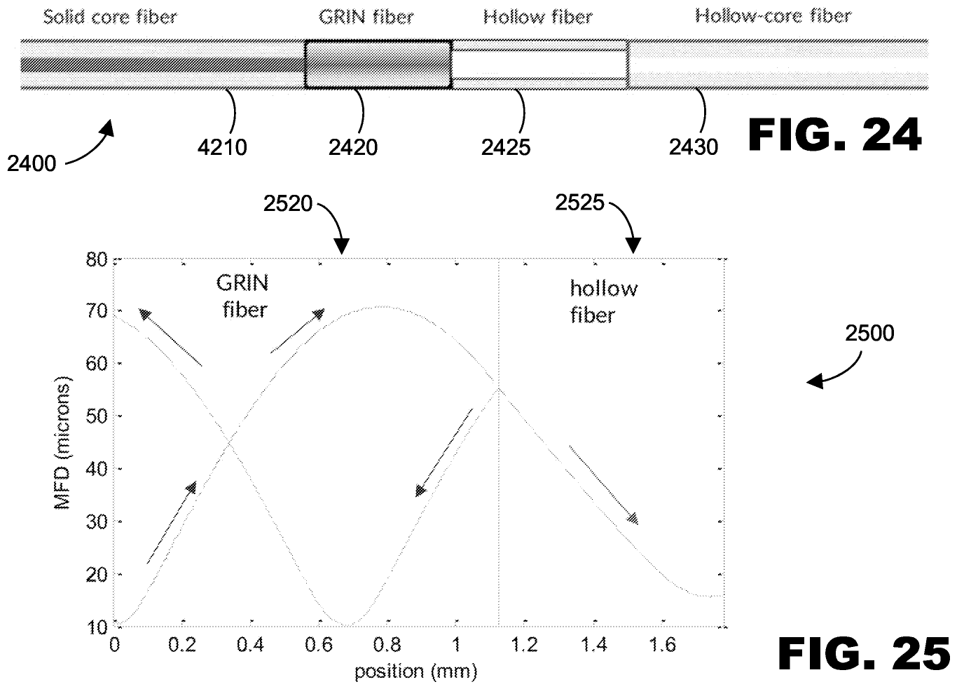

Unlike systems that require these types of mechanical connectors 140, 150, the present disclosure teaches all-fiber systems and methods for optically coupling a solid-core fiber (SCF) with a hollow-core fiber (HCF) without additional mechanical connectors. Some embodiments of the inventive system use a combination of a graded-index (GRIN) fiber with a hollow fiber (HF) (similar to that shown in FIG. 24). The GRIN fiber and HF reside between the SCF and the HCF and provide an optical pathway between the SCF with the HCF. The combination of the GRIN fiber with the HF permits mode matching between the SCF and the HCF, while concurrently increasing return loss from the HCF to the SCF. In other embodiments, an additional coreless fiber resides between the SCF and the GRIN fiber (similar to that shown in FIG. 4).

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

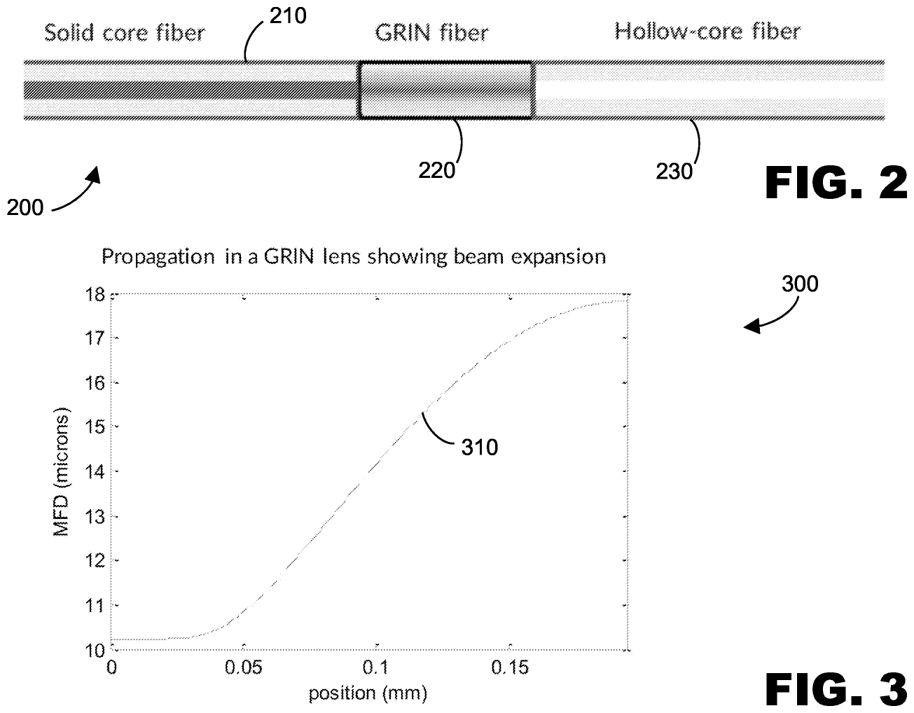

By way of background, FIG. 2 illustrates a system 200 having a GRIN fiber 220 (or GRIN lens or simply denoted as GRIN) connected between a SCF 210 and a HCF 230, with a corresponding graph 300 (shown in FIG. 3) of beam propagation 310 for the GRIN 220. In the graph, 300, position (in millimeters (mm)) along the propagation direction is on the horizontal axis (hereafter designated as “X-axis” or simply “X”), while mode-field diameter (MFD) (in micrometers (μm) or microns) is along the vertical axis (hereafter designated as “Y-axis” or simply “Y”). As shown in FIG. 3, the MFD expands as the beam propagates through the GRIN 220 from the SCF 210 to the HCF 230. Because there exists a glass-air interface between the GRIN 220 and the HCF 230, and because the beam at the exit to the GRIN fiber into the hollow core fiber is optimized with a flat phase for optimal coupling into the HCF, any reflection at this glass-air interface propagates directly back into the core of the SCF 210. Thus, while the GRIN 220 provides low-loss coupling, the GRIN 220 (standing alone) does not provide a high-return-loss coupling.

To provide both a low coupling loss and a high return loss, the embodiments disclosed herein teach a physical separation between the GRIN and the HCF by, for example, providing a hollow fiber (HF) 425, such as that shown in FIG. 4. Specifically, the embodiment of FIG. 4 shows a SCF-to-HCF connector system 400 using a combination of a coreless fiber 415, a GRIN 220, and a hollow fiber (HF) 425, all residing between a SCF 410 and a HCF 430. Preferably, the entire all-fiber system 400 is fusion spliced, thereby eliminating the need for FC/PC or other types of mechanical connectors.

In such a system, a glass-air interface 435 exists between the glass in the GRIN 420 and the air in the HF 425. An optical signal propagates through such an all-fiber system sequentially from the SCF 410, through the coreless fiber 415, through the GRIN 420, past the glass-air interface 435, and through the HF 425, finally reaching the HCF 430. Specifically, each of the fibers 415, 420, 425 is designed with particular dimensions and characteristics such that the optical beam exiting the SCF 410 expands as it propagates through the coreless fiber 415 (meaning, the MFD becomes larger as it propagates through the coreless fiber 415). The expanded beam enters the GRIN 420, where the beam is partially (but not fully) focused, thereby decreasing the MFD of the optical beam. As the partially focused optical beam exists the GRIN 420, the optical beam continues to focus in the HF 425 (which acts as a free space section), eventually becoming fully focused and mode-matched with the HCF 430 as the optical beam enters the HCF 430.

In the backward direction, the optical beam reflects at the glass-air interface 435 and the MFD of the optical beam evolves based on the optical properties of the GRIN 420. As the backward-propagating optical beam emerges from the GRIN 420 and enters the coreless fiber 415, the backward-propagating optical beam further evolves with the MFD preferably expanding significantly as the optical beam propagates backward to the SCF 410. If the MFD of the optical beam as it reaches the SCF 410 is substantially larger than the SCF 410 core, then a significant return loss can be observed due to mode mismatch. For some embodiments, a return loss that is greater than ˜30 dB is achievable.

One example of an optical beam's behavior in both forward-propagating and backward-propagating directions is shown in FIG. 5. Specifically, the graph 500 of FIG. 5 shows MFD (along Y) as a function of fiber position (along X) as the optical beam propagates forward and backward in the coreless fiber region 515, the GRIN region 520, and the HF region 525, all of which correspond to the coreless fiber 415, the GRIN 420, and the HF 425 of the SCF-to-HCF system 400 of FIG. 4. It should be appreciated that the beam propagation behavior shown in FIG. 5 can also result from beam propagation calculations (by beam propagation algorithms that are used in the art and familiar to those having ordinary skill in the art). The specific graph 500 of FIG. 5 shows beam propagation calculations for a 20 μm-MFD SCF 410 and a 15 μm-MFD HCF 430, with ˜1.9 mm-length coreless fiber 515, ˜2.4 mm-length GRIN 520, and ˜1.2 mm-length HF 525 interposed in the optical beam propagation pathway between the SCF 410 and the HCF 430.

Those having ordinary skill in the art will understand that, to appropriately design the optical system 400, the particular dimensions and characteristics of each fiber section are determined using beam propagation calculations, which are executed by computer programs that are known in the art. Such beam propagation calculations permit optimization of optical systems by providing suitable parameters that are calculated for coreless fiber length, hollow fiber length, GRIN fiber length, GRIN parameter (g (typically in inverse meters (m⁻¹ or 1/m)), GRIN index difference (Δn), HF inner diameter (ID), and a host of other parameters that govern the behavior of the MFD of an optical beam. The use of these well-known algorithms or computational tools permit beam propagation calculations, which in turn provide the parameters for the design of each of the fibers 415, 420, 425. Because beam propagation calculations (and the computational tools for such calculations as well as the resulting parameters (e.g., g, Δn, etc.)) are well known to those having skill in the art, only a truncated discussion of beam propagation calculations is provided herein.

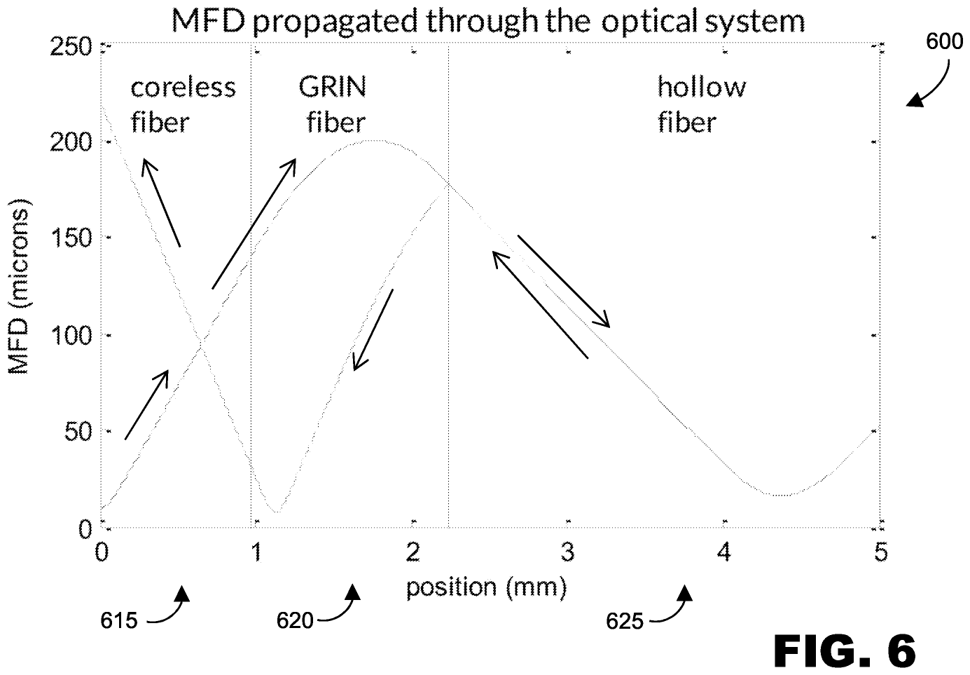

FIG. 6 is a graph 600 showing MFD (along Y) as a function of fiber position (along X) as an optical beam propagates forward and backward in the coreless fiber region 615, the GRIN fiber region 620, and the HF region 625 in another embodiment of a SCF-to-HCF connector system. As shown in FIG. 6, the graph 600 represents calculations for ˜0.95 mm-length coreless fiber 615, ˜1.25 mm-length GRIN 620, and ˜2.8 mm-length HF 625 with the optical beam propagation being shown in both the forward direction and the backward direction (shown with directional arrows). Comparing FIG. 6 to FIG. 5, one can see how the forward path and the backward path are remarkably different in the coreless fiber 515, 615 and the GRIN 520, 620 regions, with the backward propagating optical beam having high return loss after back-propagating through the coreless fiber 515, 615. In other words, for a given g, input MFD (meaning, the MFD of the optical beam immediately after it exits the SCF), output MFD (meaning, the MFD of the optical beam immediately before it enters the HCF), and operating center wavelength (λ), the optical beam propagates slightly differently through the optical system. In particular, the graph 600 of FIG. 6 shows the MFD actually increasing after it reaches a minimum (at a fiber position that is ˜4.3 mm away from the SCF).

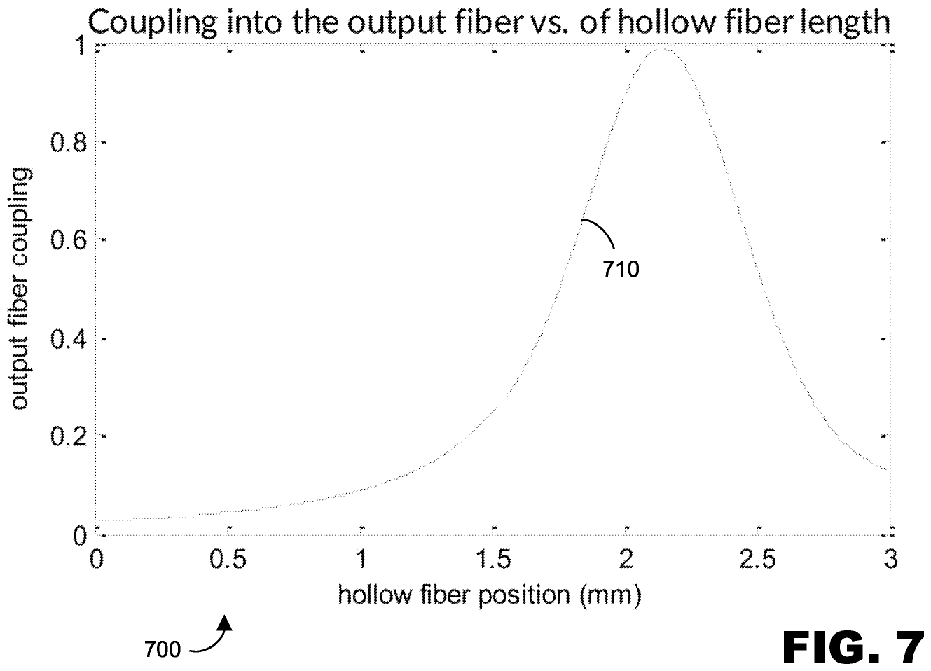

Coupling into the output HCF is calculated as a function of position (along the HF) using an overlap integral between the propagated optical beam and the fundamental mode of the HCF. FIG. 7 is a graph 700 showing output fiber coupling (along Y) 710 as a function of HF position (along X) in accordance with one embodiment of the invention. The position of maximum coupling (meaning, lowest coupling loss). Thus, as shown in FIG. 7. the maximum occurs at a HF position of ˜2.1 mm, which corresponds to the minimum in FIG. 6 at ˜4.3 mm. Coupling backward into the SCF is calculated using the overlap integral between the fundamental mode of the SCF and the beam reflected at the glass-air interface at one end of the GRIN. The lengths of both the coreless fiber and the GRIN are optimized using a multidimensional minimization algorithm (or other routine or optimization program) that minimizes the parameter:

$${f}_{opt} = 1 - output coupling + input coupling . \qquad [ Eq . 1 ]$$

Preferably, equal weight is given to the input coupling loss and the output coupling loss. However, for other embodiments, the input coupling loss factor and the output coupling loss factor can be weighted differently. Ultimately, design optimization balances the parameters to find the best balance between the lowest output coupling loss and the highest return loss. In the particular case of Eq. 1, the optimal length of the HF is not a part of the minimization routine.

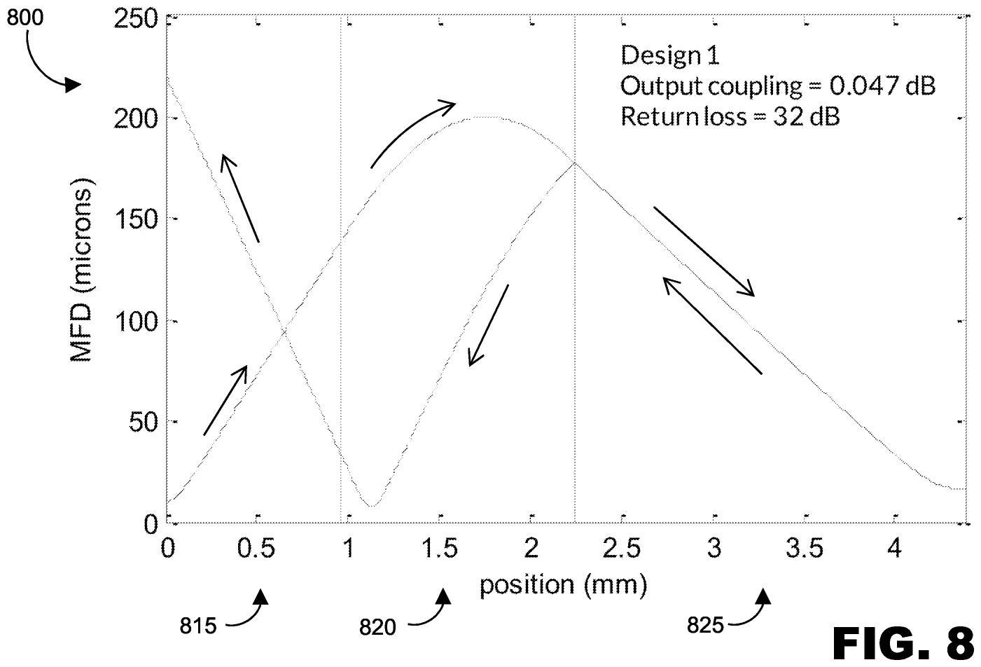

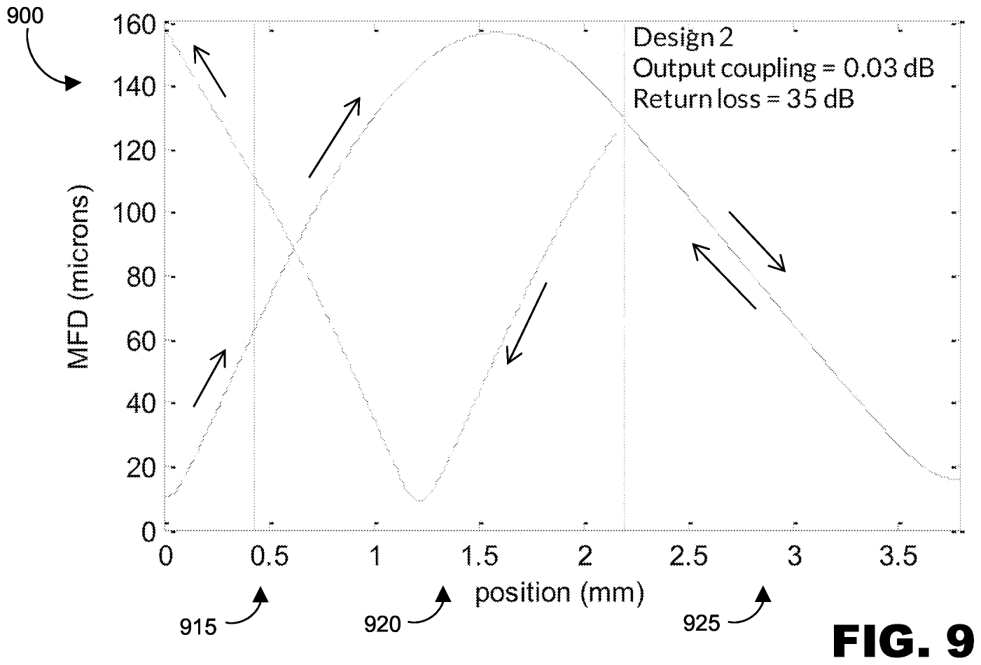

For a given g, input MFD, output MFD, and 2, an optimizer (or optimization algorithm or routine) can find different designs with similar performances. An example comparison is shown in FIG. 8 (labeled as Design-1) and 9 (labeled as Design-2). FIGS. 8 and 9 are graphs 800, 900 showing MFD (along Y) as a function of fiber position (along X) as an optical beam propagates forward and backward in the coreless fiber region 815, 915, the GRIN region 820, 920, and the HF region 825, 925. Specifically, in both FIG. 8 and FIG. 9:

$$g = 1000 {m}^{- 1} ; \qquad [ Eq . 2 ]$$

$$GRIN maximum Δ n = 0.0 \; 15 ; \qquad [ Eq . 3 ]$$

$$λ = 1550 nanometers ( nm ) ; \qquad [ Eq . 4 ]$$

$$Input MFD = 10 μm ; \qquad [ Eq . 5 ]$$

$$Output MFD = 16.7 μm ; \qquad [ Eq . 6 ]$$

$$HF ID = 400 μm . \qquad [ Eq . 7 ]$$

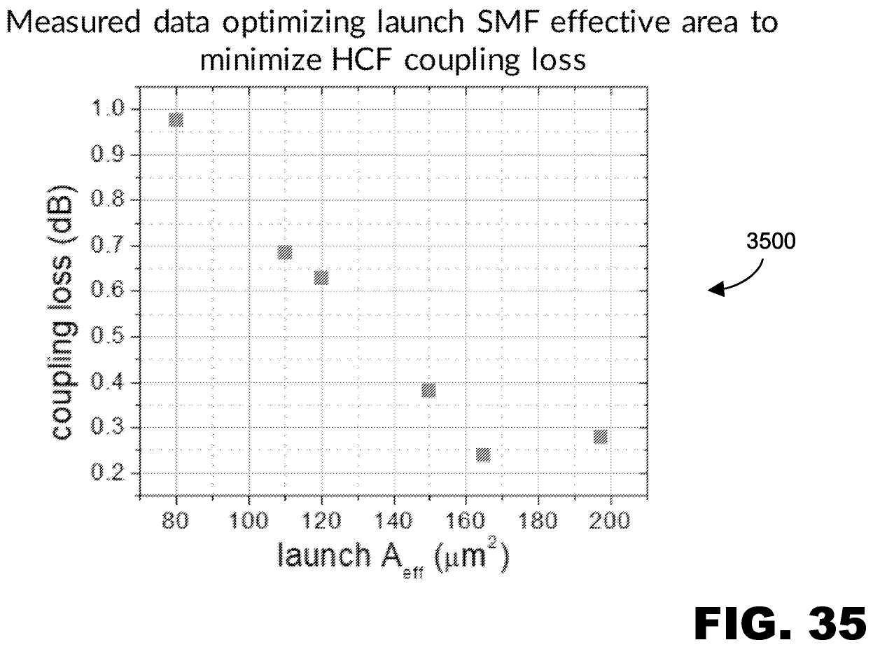

From these graphs, one can see that the output coupling losses (0.048 dB in FIGS. 8 and 0.03 dB in FIG. 9) are substantially similar, as are the return losses (32 dB in FIGS. 8 and 35 dB in FIG. 9). Nevertheless, even though several parameters are substantially the same, the two designs (represented as graphs 800, 900) show remarkably different fiber lengths (e.g., GRIN length in FIG. 8 is ˜1.3 mm, while GRIN length in FIG. 9 is ˜1.8 mm; the coreless fiber length in FIG. 8 is ˜1 mm, while the coreless fiber length in FIG. 9 is ˜0.4 mm, etc.) and remarkably different MFDs in the GRIN (see graphs). Consequently, if the HF ID is made smaller, then that change in the HF ID will affect the two designs 800, 900 differently.

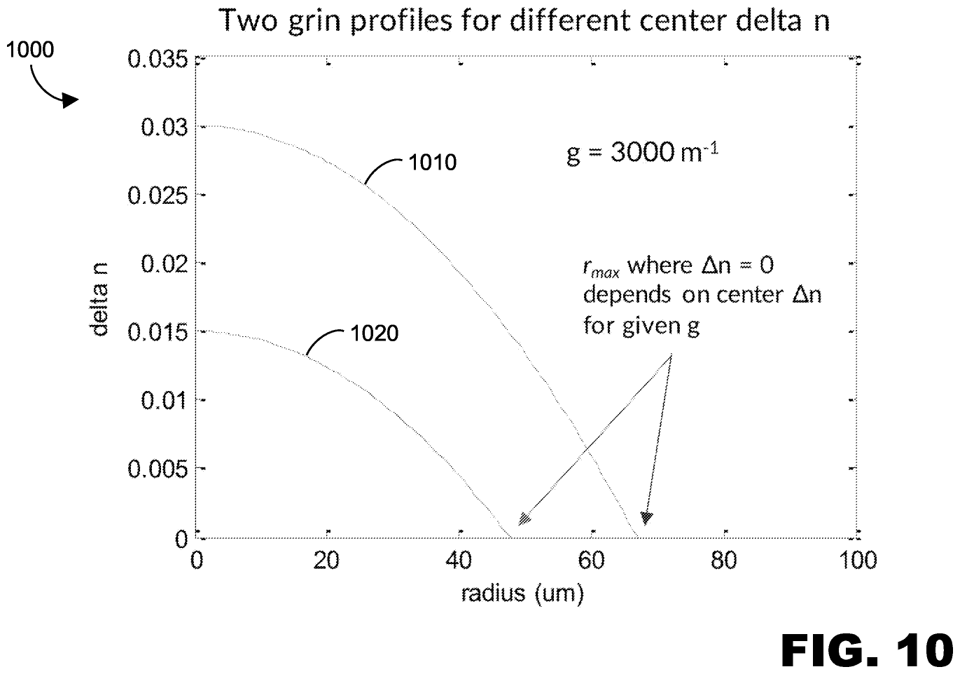

FIG. 10 is a graph 1000 comparing a first GRIN profile 1010 with a second GRIN profile 1020 with a different index difference (Δn), with Δn along Y and MFD radius along X in accordance with one embodiment of the invention, specifically, where g is 3,000 m⁻¹. Specifically, FIG. 10 teaches that a GRIN core size and a HF ID are limiting apertures in the optical system. If either is too small compared to the MFD of the beam in the GRIN, then the beam will be clipped, thereby causing a degradation in performance. Thus, for any given g, the radius (r) where the GRIN profile approaches zero (0) depends on the center Δn. By way of example, for the equation for Δn (r), the index profile of a parabolic GRIN is:

$$Δ n ( r ) = ( Δ {n}_{0} + {n}_{cladding} ) √ ( 1 - ( {r}^{2} \cdot {g}^{2} ) ) , \qquad [ Eq . 8 ]$$

where r is a radius of the GRIN, g is the GRIN parameter, Δn is the index at r of zero (r=0), and n_{cladding} is an index of the cladding. The GRIN profile reaches the cladding index (at Δn=0) at a maximum radius (rₘₐₓ), such that:

$${r}_{max} = ( 1 / g ) \cdot √ ( 1 ( {( {n}_{cladding} / ( Δ {n}_{0} + {n}_{cladding} ) )}^{2} ) , \qquad [ Eq . 9 ]$$

which shows the relevance of rₘₐₓ and the inner radius (IR) of the HF in design considerations.

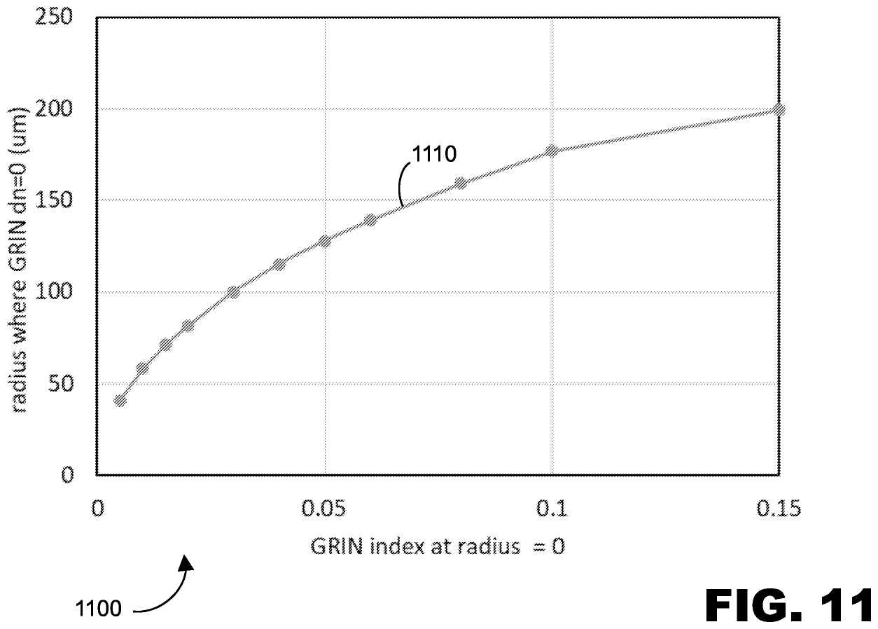

FIG. 11 is a graph 1100 plotting GRIN radius where Δn=0 (along Y) as a function of GRIN index at MFD radius (r) of 0 in accordance with one embodiment of the invention. As shown in FIG. 11, the GRIN profile reaches the cladding index (Δn=0) at the radius defined in Eq. 9.

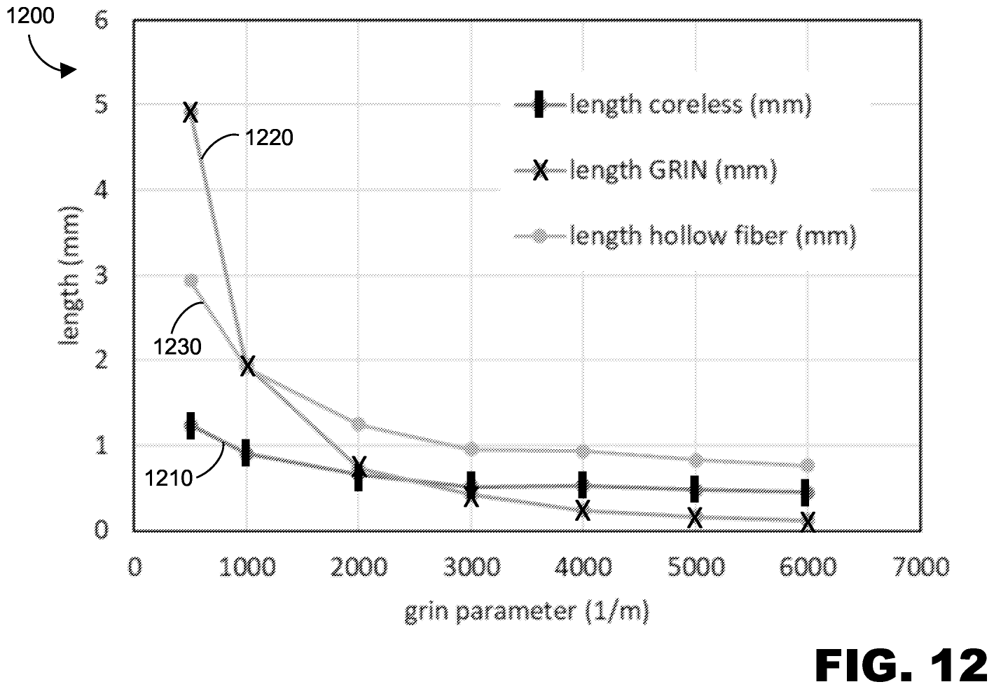

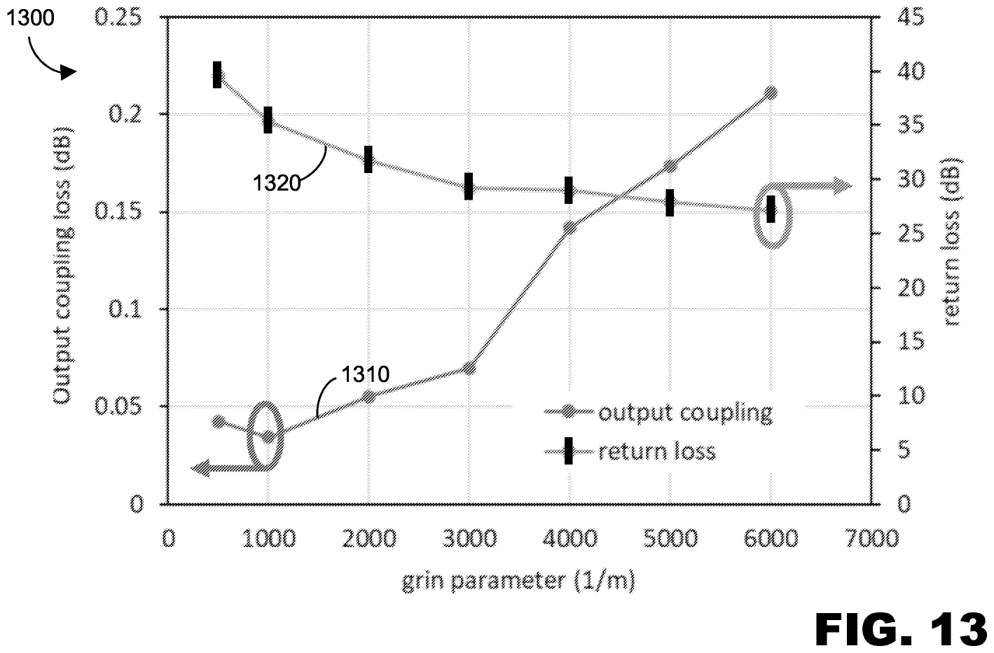

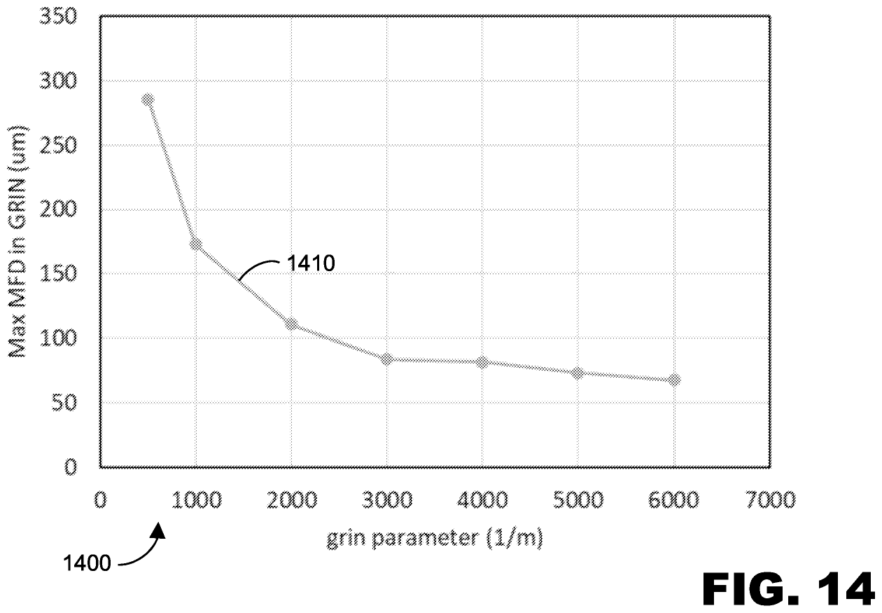

FIG. 12 is a graph 1200 plotting lengths (in units of mm) of a coreless fiber 1210, a GRIN fiber 1220, and a HF 1230 along Y as a function of a GRIN parameter (in units of inverse meters (1/m)) along X in accordance with one embodiment of the invention. FIG. 13 is a graph 1300 plotting both output coupling loss 1310 (in units of decibels (dB)) and return coupling loss 1320 (dB) along Y, both as a function of the GRIN parameter (1/m) along X in accordance with one embodiment of the invention. FIG. 14 is a graph 1400 plotting a maximum MFD (μm) in the GRIN fiber along Y as a function of the GRIN (1/m) parameter along X in accordance with one embodiment of the invention. As shown in FIGS. 12, 13, and 14, a simulation setup at an operating center wavelength (λ) of approximately 1550 nanometers (λ=˜1550 nm), input MFD of ˜10 μm, an output MFD of ˜16.7 μm, solid-core input fiber, solid-core output fiber, GRIN Δnₘₐₓ of 0.4, and HF ID of ˜400 μm is shown. GRIN Δn=0.4 and HF ID of ˜400 μm (although both values are exaggerated) allow evaluation of system performance with little-to-no impact of apertures on system performance. Specifically, as shown in FIGS. 12 through 14, as the GRIN parameter (g) becomes smaller (meaning, looser focusing by the GRIN):
lengths of the coreless fiber, GRIN fiber, and HF become longer;
coupling loss into the HCF output fiber becomes lower;
return loss from the reflected beam becomes higher;
maximum MFD in the GRIN becomes larger;
output coupling becomes worse for higher g because input coupling decreases due to smaller MFD in the GRIN; and
optimization routine becomes balancing input and output coupling.

From FIGS. 12 through 14, presuming g=500 m⁻¹, an output coupling loss of ˜0.04 at the 3 dB point, and a return loss of ˜39 dB, a smaller g improves performance, but the optical coupling system becomes more susceptible to GRIN and HF apertures due to larger MFD in GRIN.

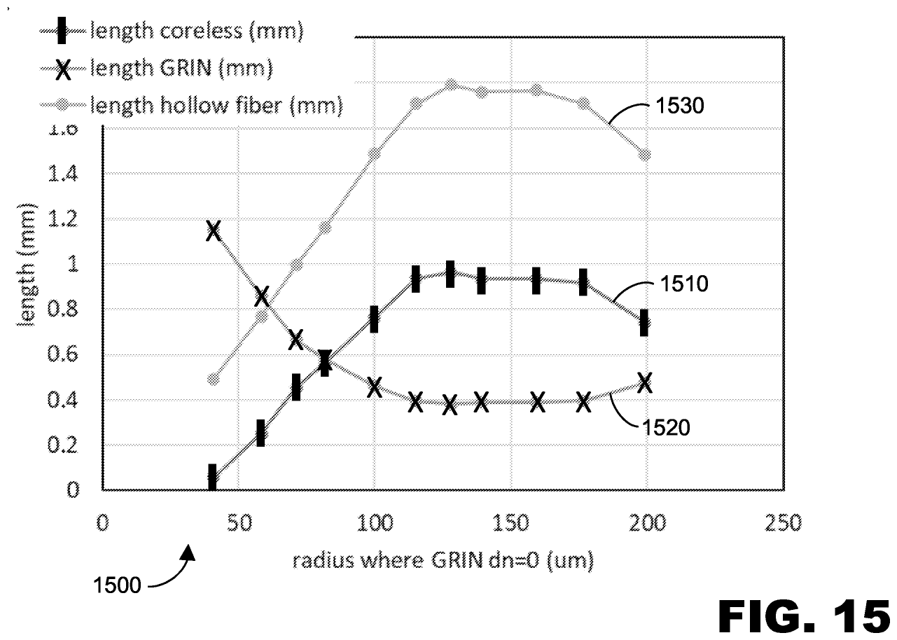

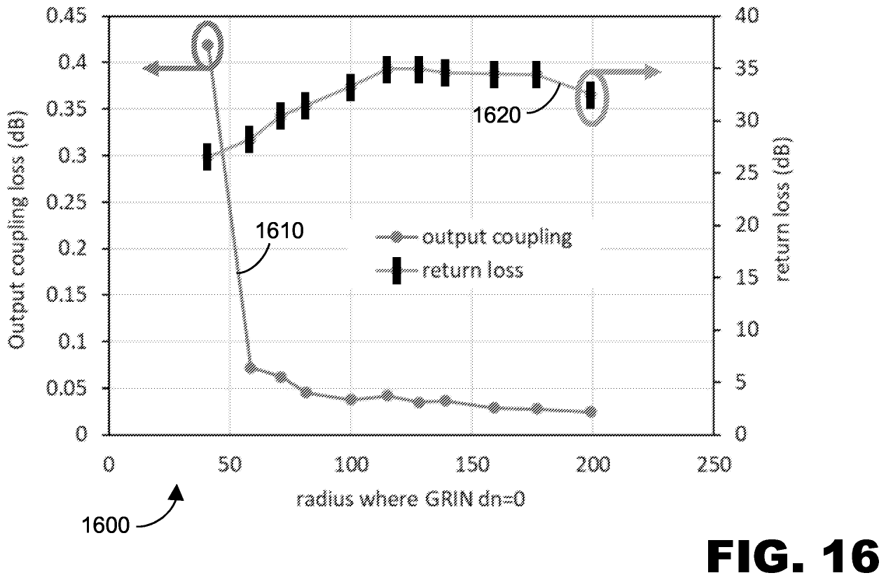

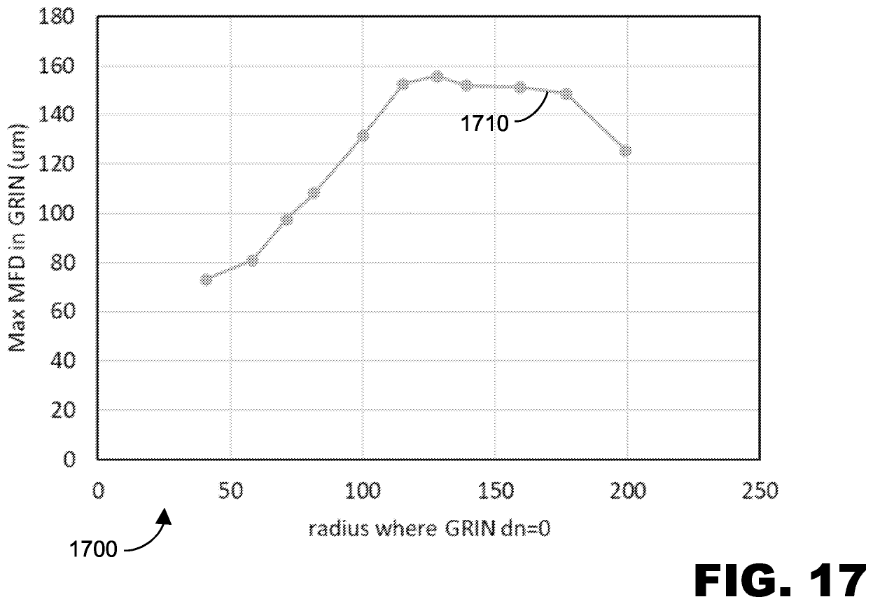

Continuing, FIGS. 15, 16, and 17 show graphs that demonstrate an impact of GRIN aperture with a finite radius, r. Specifically, FIG. 15 is a graph 1500 plotting lengths (mm) of a coreless fiber 1510, a GRIN fiber 1520, and a HF 1530 along Y as a function of a radius (μm) where GRIN Δn=0 along X in accordance with one embodiment of the invention; FIG. 16 is a graph 1600 plotting both output coupling loss 1610 (dB) and return coupling loss 1620 (dB) along Y, both as a function of radius (μm) where the GRIN Δn=0 along X in accordance with one embodiment of the invention; and FIG. 17 is a graph 1700 plotting maximum MFD (μm) in a GRIN fiber 1710 along Y as a function of radius (μm) where the GRIN Δn=0 along X in accordance with one embodiment of the invention. Specifically, FIGS. 15 through 17 show a system having input MFD=˜10 μm, output MFD=˜16.7 μm, λ=˜1550 nm, HF ID=˜400 μm, g=˜2000 m⁻¹, SCF input fiber, and SCF output fiber. For such a system, one can determine from FIGS. 15, 16, and 17 that, as the GRIN Δn becomes smaller:
the GRIN core begins clipping the optical beam;
the optimization algorithm determines optimum fiber lengths to be shorter for the coreless fiber and the HF, but longer for the GRIN fiber;
the MFD reduces in the GRIN fiber to compensate for the effect of the aperture;
coupling loss to the output fiber (namely, the HCF) increases;
return loss to the input fiber (namely, the SCF) decreases; and
below a certain GRIN Δn and core r, the optimization algorithm is no longer able to find a low-loss output coupling as the coreless fiber length approaches zero.

Thus, at least for the embodiment of FIGS. 15, 16, and 17, in which GRIN r=˜71 μm and GRIN Δn=˜0.015, the output coupling loss is ˜0.06 dB, while the return loss is ˜30 dB.

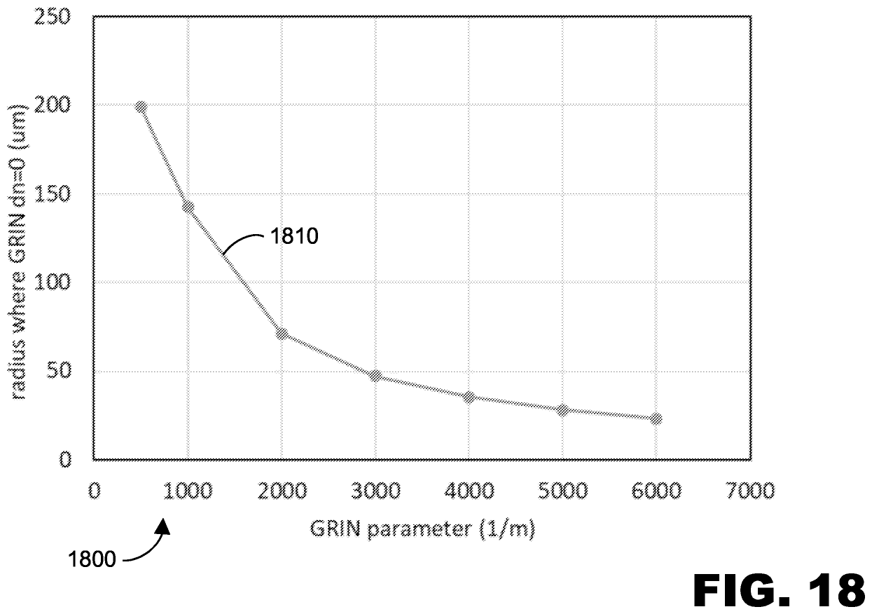

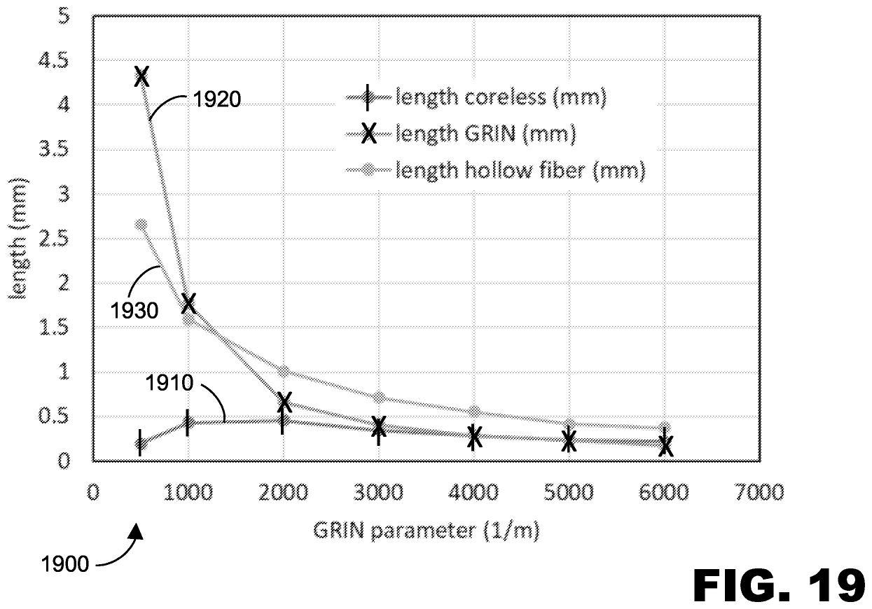

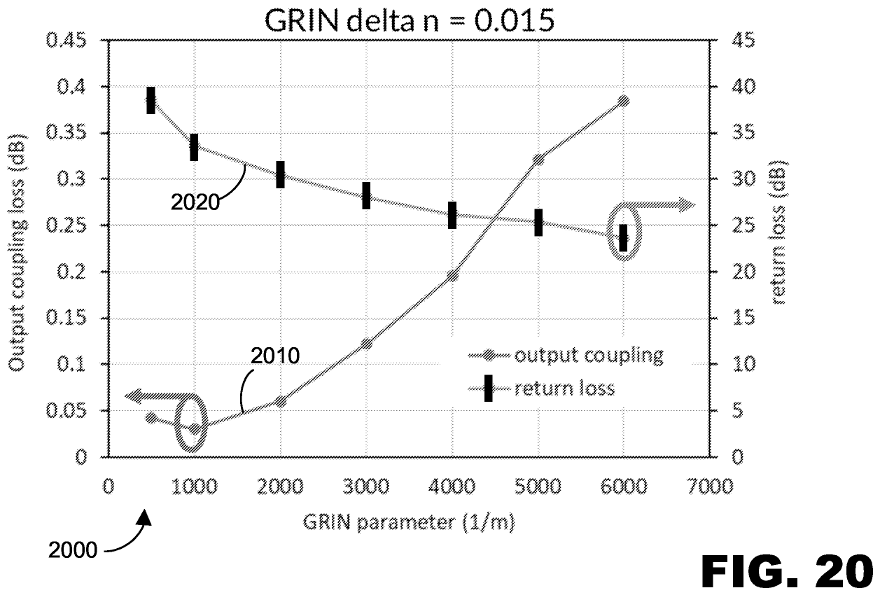

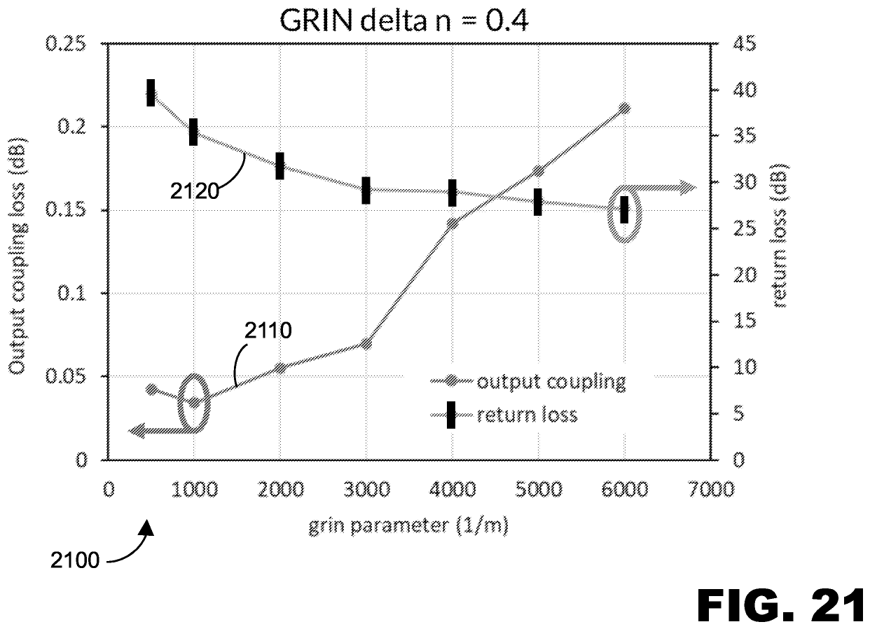

Turning to FIGS. 18 through 21, shown are graphs for an optimal design for GRIN Δn of ˜0.015. Specifically, FIG. 18 is a graph 1800 plotting radius (μm) where the GRIN Δn=0 along Y as a function of GRIN parameter (1/m) along X in accordance with one embodiment of the invention; FIG. 19 is a graph 1900 plotting lengths (mm) of a coreless fiber 1910, a GRIN fiber 1920, and a HF 1930 along Y as a function of a GRIN parameter (1/m) along X in accordance with one embodiment of the invention; FIG. 20 is a graph 2000 plotting both output coupling loss 2010 (dB) and return coupling loss 2020 (dB) along Y, both as a function of the GRIN parameter (1/m) along X in accordance with one embodiment of the invention; and FIG. 21 is a graph 2100 plotting both output coupling loss 2110 (dB) and return coupling loss 2120 (dB) along Y, both as a function of the GRIN parameter (1/m) along X in accordance with one embodiment of the invention. As the GRIN parameter (g) increases (meaning, a tighter focusing lens), the GRIN aperture becomes smaller. Thus, output coupling loss becomes worse at larger g values when compared to calculations with GRIN Δn of ˜0.04. But, return loss and output coupling loss at small g values remains relatively unchanged with lower GRIN Δn values because aperture becomes relatively large.

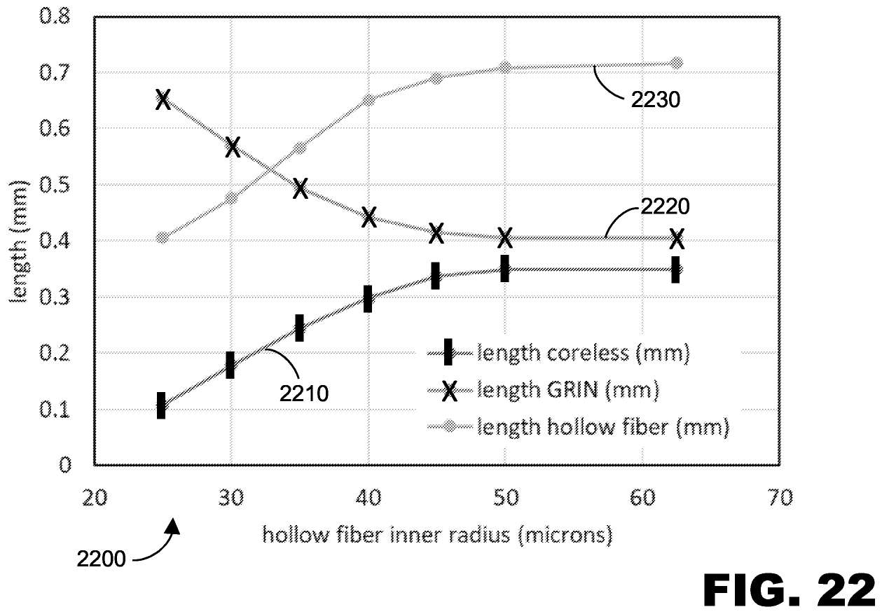

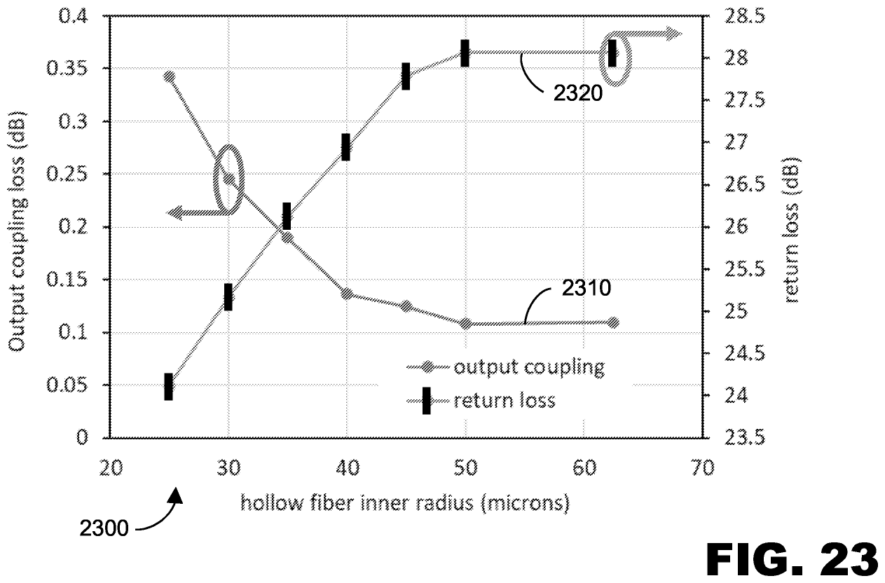

Consequently, as demonstrated from the values in FIGS. 22 and 23, when all relevant apertures are considered, a reasonable coupling loss is obtainable for standard optical fibers (namely, those that comply with the International Telecommunications Union, Telecommunications (ITU-T) Standards, which are well known by those having ordinary skill in the art) that are compatible with HCFs having an outer diameter (OD) of ˜125 μm. Specifically, FIG. 22 is a graph 2200 plotting lengths (mm) of a coreless fiber 2210, a GRIN fiber 2220, and a HF 2230 along Y as a function of a GRIN parameter (1/m) along X in accordance with one embodiment of the invention; and FIG. 23 is a graph 2300 plotting both output coupling loss 2310 (dB) and return coupling loss 2320 (dB) along Y, both as a function of the GRIN parameter (1/m) along X in accordance with one embodiment of the invention. For the simulation results of FIGS. 22 and 23, the input MFD=˜10 μm, the output MFD=˜16.7 μm, the input and output fibers are both SCF, the GRIN r is ˜47.2 μm, 2=˜1550 nm, g=˜3000 m⁻¹, and GRIN Δn=˜0.015. Once the HF IR becomes smaller than the GRIN core r, the HF further clips the optical beam. Thus, to operate with a HCF having an OD of ˜125 μm, the HF ID should be less than ˜125 μm. By way of example, for a HF ID of ˜90 μm (an IR of ˜45 μm), the output coupling loss is ˜0.12 dB, while the return loss is ˜27.7 dB.

Turning now to another embodiment of an optical coupling system, FIG. 24 is a diagram showing a SCF-to-HCF connector system 2400 using a combination of a coreless a GRIN fiber 220 and a HF 2425, but without a coreless fiber (such as that shown in the embodiment of FIG. 4). Without the coreless fiber, an example evolution of both a forward-propagating optical beam and a backward-propagating optical beam are shown in FIG. 25 for λ=˜1550 nm. Specifically, FIG. 25 is a graph 2500 plotting both forward and backward beam-propagation behavior in the GRIN fiber region 2520 and the HF region 2525, with MFD (μm) along Y as a function of position (mm) along X in accordance with one embodiment of the invention.

For any given absolute index at r=0 (designated as no), operating center wavelength (λ), and g, a mode-field diameter (MFD₀) exists that does not increase or decrease significantly when propagated through the GRIN. MFD₀ is given by:

$${MFD}_{0} = 2 \cdot √ ( λ / ( π \cdot {n}_{0} \cdot g ) ) . \qquad [ Eq . 10 ]$$

Thus, at λ=˜1550 nm, g=˜2000 m⁻¹, Δn=0.015, and a cladding index (no)=˜1.444, the MFD₀ is:

$$\begin{matrix}{MFD}_{0} & = ∼ ( 2 \cdot √ ( 1550 nm / ( π \cdot 1.444 \cdot 2000 {m}^{- 1} ) ) ) \\ & = ∼ 26 μm\end{matrix} . \qquad [ Eq . 11 ]$$

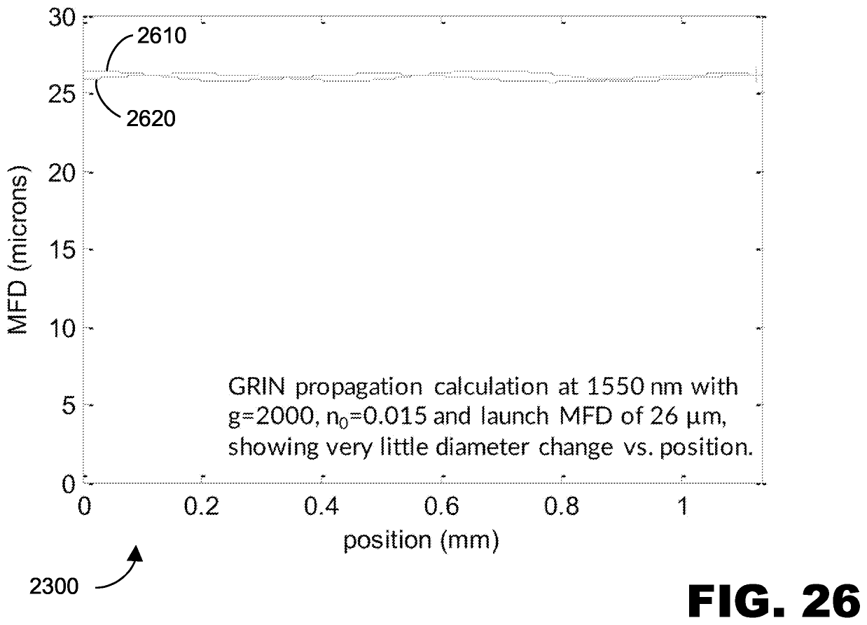

Furthermore, as shown in the graph 2600 of FIG. 26 (which compares two (2) GRIN propagation calculations 2610, 2620 (one with a coreless fiber and one without a coreless fiber), with MFD (μm) along Y and position (mm) along X), there is negligible change in the MFD as a function of position.

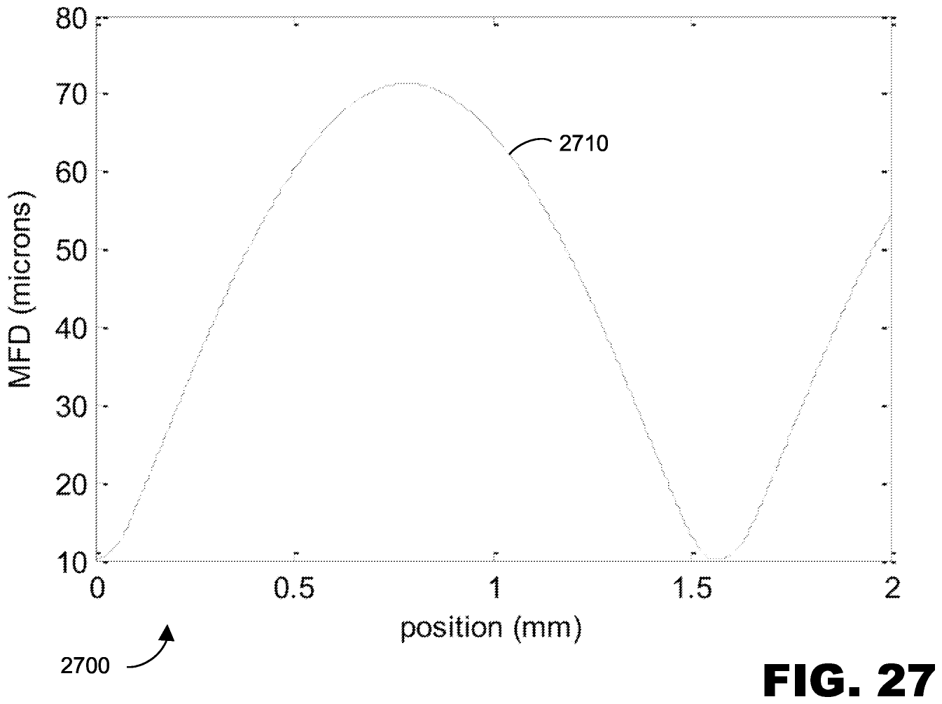

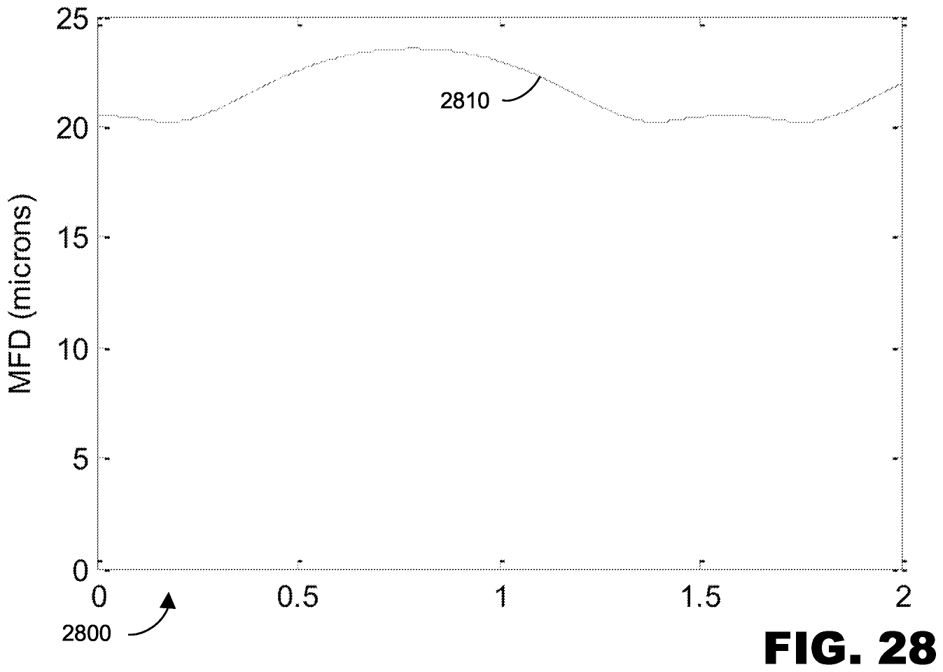

According to Eq. 10, the MFD₀ is λ-dependent. Comparing typical conditions for telecommunications applications (at λ=˜1550 nm) and laser applications (at λ=˜1070 nm) shows that the input MFD and MFD₀ within the GRIN is remarkably different. Specifically, FIG. 27 is a graph 2700 showing behavior of MFD 2710 from an input of a GRIN fiber to an output of the GRIN fiber for a telecommunications (telecom) application with 2=˜1550 nm, showing MFD (μm) along Y and position (mm) along X; and FIG. 28 is a graph 2800 showing behavior of MFD 2810 from an input of a GRIN fiber to an output of a GRIN fiber for a laser application with λ=˜1070 nm, showing MFD (μm) along Y and position (mm) along X. As shown in FIG. 27, the optical beam expands significantly (from input MFD of ˜10 μm to MFD₀ of ˜26 μm) for telecom applications, but as shown in FIG. 28, there is no significant optical beam expansion for laser applications (from input MFD of ˜20.5 μm to MFD₀ of ˜21.6 μm).

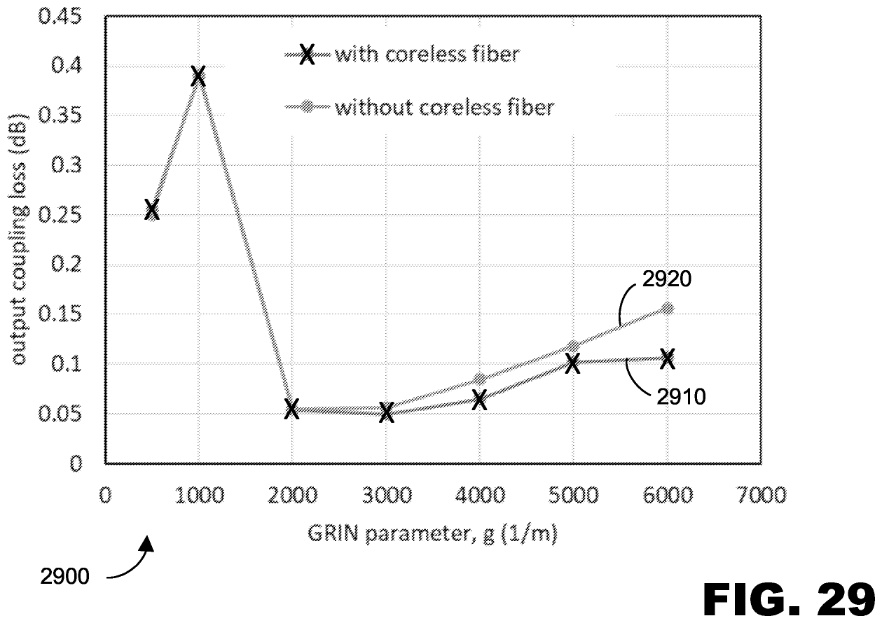

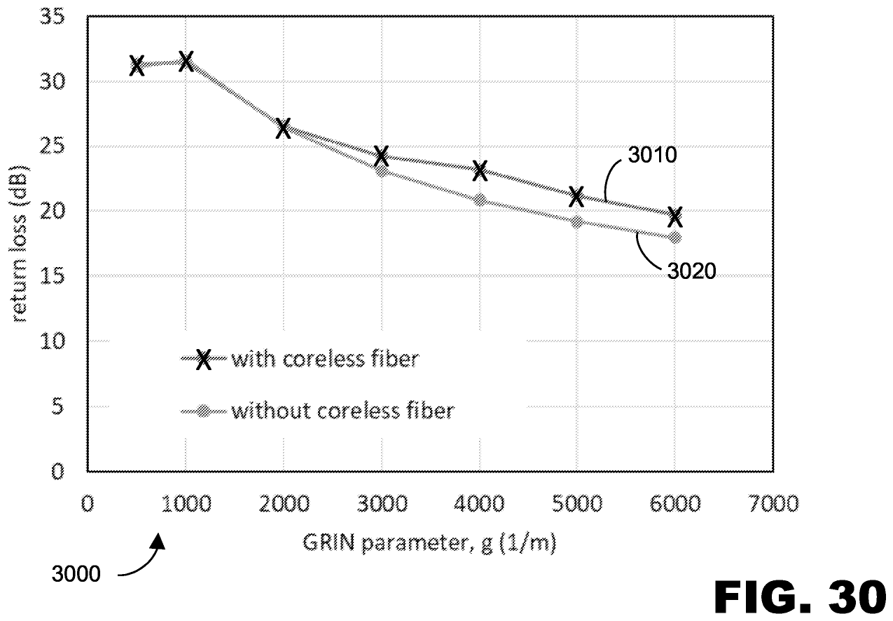

To further demonstrate the differences between systems with a coreless fiber (e.g., FIG. 4) and systems without a coreless fiber (e.g., FIG. 24), output coupling loss and return loss are shown in FIGS. 29 and 30, respectively. FIG. 29 is a graph 2900 showing output coupling loss (dB) for a system with a coreless fiber 2910 in comparison to a system without a coreless fiber 2920, with output coupling loss (dB) along Y and GRIN parameter (1/m) along X; and FIG. 30 is a graph 3000 showing return loss (dB) for a system with a coreless fiber 3010 in comparison to a system without a coreless fiber 3020, with return loss (dB) along Y and GRIN parameter (1/m) along X. For both FIGS. 29 and 30, input MFD=˜10 μm, output MFD=˜16.7 μm, λ=˜1550 nm, the input and output fibers (for the simulation) are SCFs, GRIN Δn=0.015, HF ID=˜45 μm, and the OD=˜125 μm (for all fibers in the system). As shown in FIGS. 29 and 30, at an optimal g=˜2000 m⁻¹, both systems (with the coreless fiber and without the coreless fiber) exhibit substantially identical performance characteristics, with output coupling loss of ˜0.054 dB and return loss of ˜26 dB. Thus, one can reasonably conclude that a coreless fiber is unnecessary for telecom applications at λ=˜1550, thereby simplifying the system for λ=˜1550 nm.

In other words, the use of the GRIN with the HF (but without the coreless fiber, such as that shown in FIG. 24) appears to be operable for single-mode fibers at telecom wavelengths of λ=˜1550 nm, but may not be operable for laser applications that operate at λ=˜1070 nm. Again, for comparison, the operability at 2=˜1550 nm for both variants is shown in the graphs 500 of FIG. 5 (for coreless+GRIN+HF) and 2500 of FIG. 25 (for GRIN+HF, but without the coreless fiber).

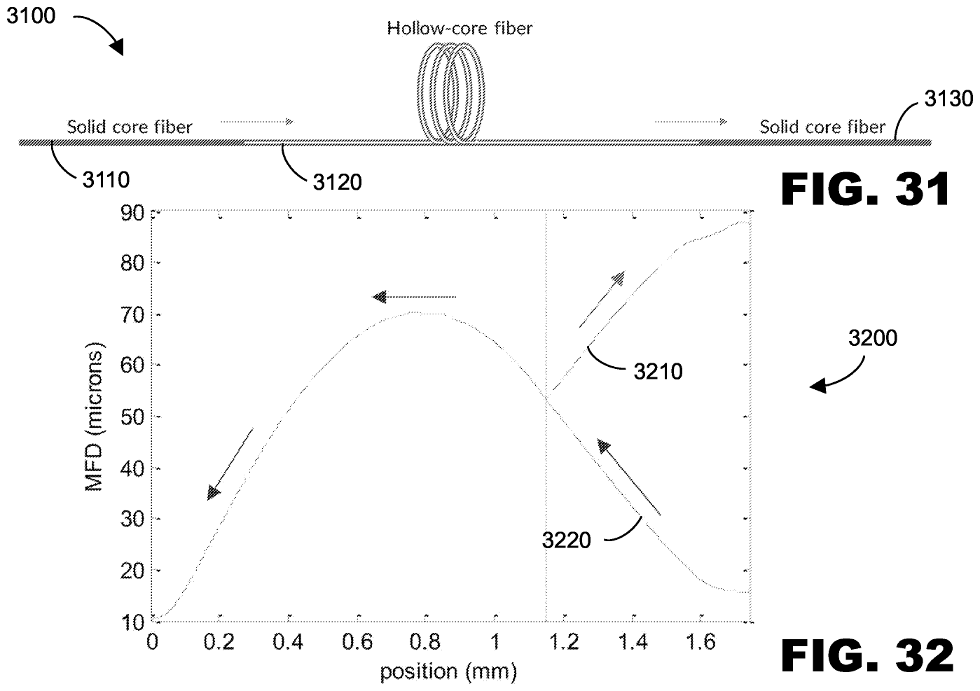

In telecom systems 3100, such as that shown in FIG. 31, signal transmission propagates from a SCF 3110 to a HCF 3120, as well as from HCF 3210 to a SCF 3130. Forward propagation in a GRIN+HF system is shown in FIG. 25. Backward propagation in a GRIN+HF system is shown in FIG. 32. Specifically, FIG. 32 is a graph 3200 showing behavior of MFD (μm) along Y as a function of position (mm) along X for a signal propagating backward in a telecom system, such as that shown in the HCF 3210 to SCF 3130 segment of FIG. 31. In the forward direction (see FIG. 25), the output coupling loss is ˜0.05 dB (low) and the return loss is ˜26.5 dB (high). In the backward direction (see FIG. 32), the output coupling loss is ˜0.04 (again, low) and the return loss is ˜26.8 dB (again, high). Thus, the embodiment of FIG. 24 is suitable for telecom applications because the HF isolates the HF from reflections at the GRIN glass-air interface, thereby providing high return loss but low output coupling loss in both forward and backward (or reverse) directions.

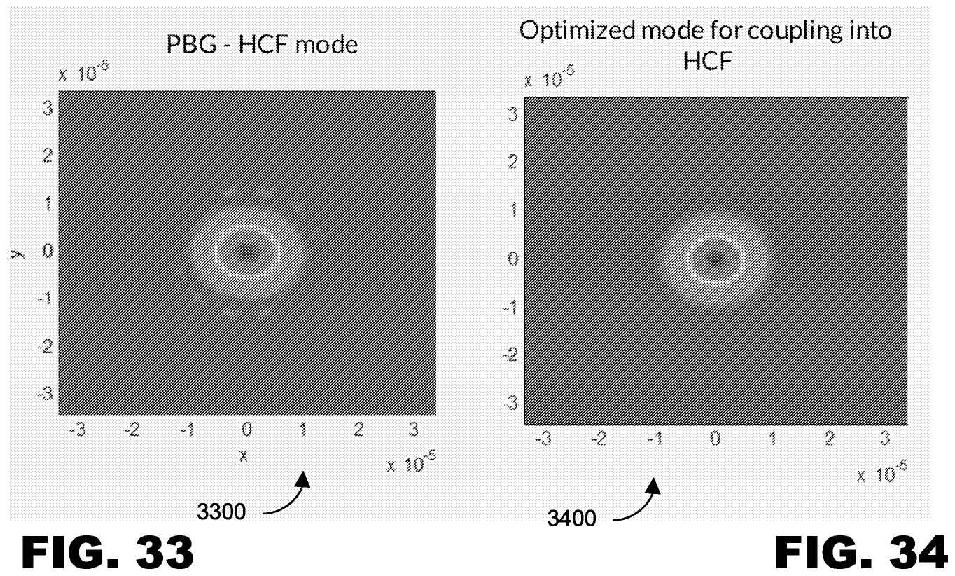

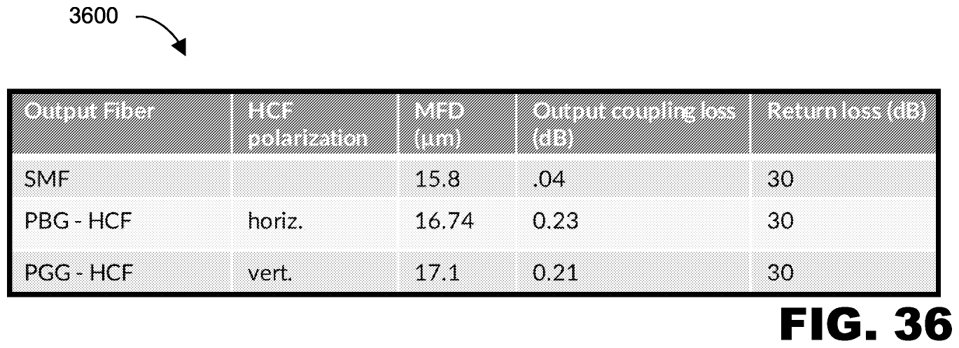

The impact of coupling into a photonic bandgap (PBG) HCF is demonstrated in FIGS. 33 through 36. Specifically, FIG. 33 is a drawing 3300 showing the mode shape of a PBG HCF; FIG. 34 is a drawing 3400 illustrating an optimized mode for coupling into a PBG HCF; FIG. 35 is a graph 3500 showing measured coupling loss (dB) along Y as a function of launch effective area (A_{eff}, in μm²) along X; and FIG. 36 is a table 3600 comparing MFD (μm), output coupling loss (dB), and return loss (dB) between a SMF, PBG-HCF (horizontal polarization), and PBG-HCF (vertical polarization). For the data in FIGS. 33 through 36, the system parameters are optimized using a SCF as an output fiber, with the SCF having a MFD that is substantially equal to a desired HCF. After optimized parameters are determined with the SCF, the SCF is swapped with a HCF for a final design, thereby taking into consideration the impact of the mode shape of the HCF on the output coupling loss. The particular simulation setup included:
input MFD of ˜10 μm;
λ of ˜1550 nm;
g of ˜2000 m⁻¹; and
GRIN Δn of ˜0.03.

Depending on whether the polarization is vertical or horizontal, PBG-HCF adds ˜0.17 dB to ˜0.19 dB of additional output coupling loss, as compared to a SCF with equivalent MFD.

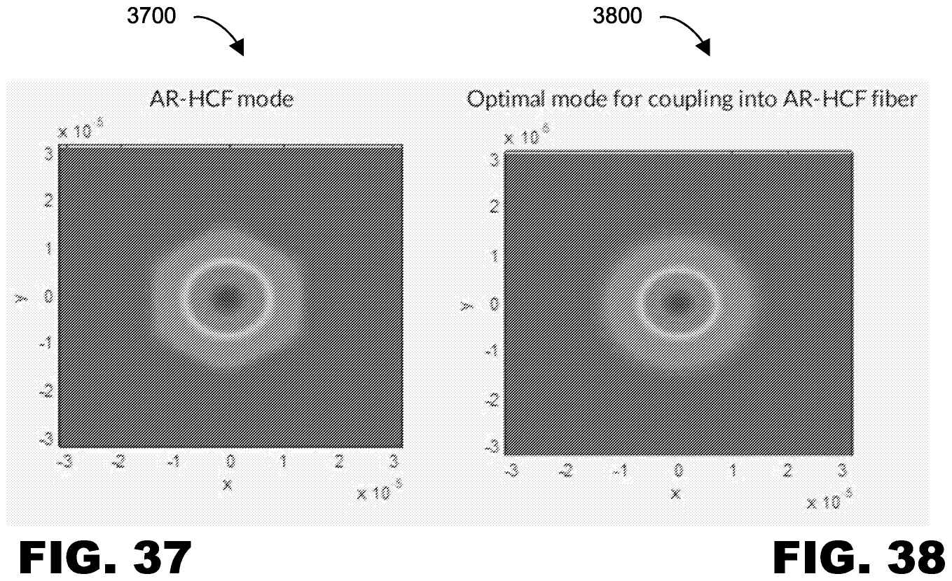

FIGS. 37 through 39 show data for coupling to anti-resonant (AR) HCF modes, again using:
input MFD of ˜10 μm;
λ of ˜1550 nm;
g of ˜2000 m⁻¹; and
GRIN Δn of ˜0.03.

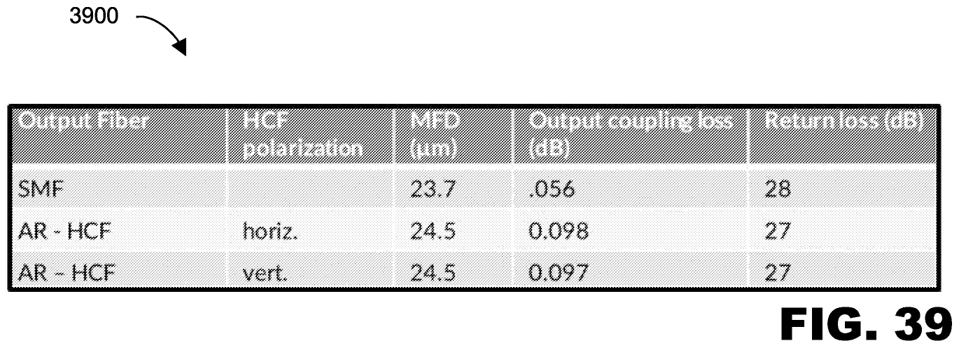

Specifically, FIG. 37 is a drawing 3700 showing the mode shape of an AR-HCF, while FIG. 38 is a drawing 3800 showing an optimal mode for coupling into AR-HCF. FIG. 39 is a table 3900 comparing MFD (μm), output coupling loss (dB), and return loss (dB) between a SMF, AR-HCF (horizontal polarization), and AR-HCF (vertical polarization). As shown from this example data set, SCF fiber modes couple better to AR-HCF than PBG-HCF. Thus, AR-HCF adds only an additional coupling loss of ˜0.04 dB.

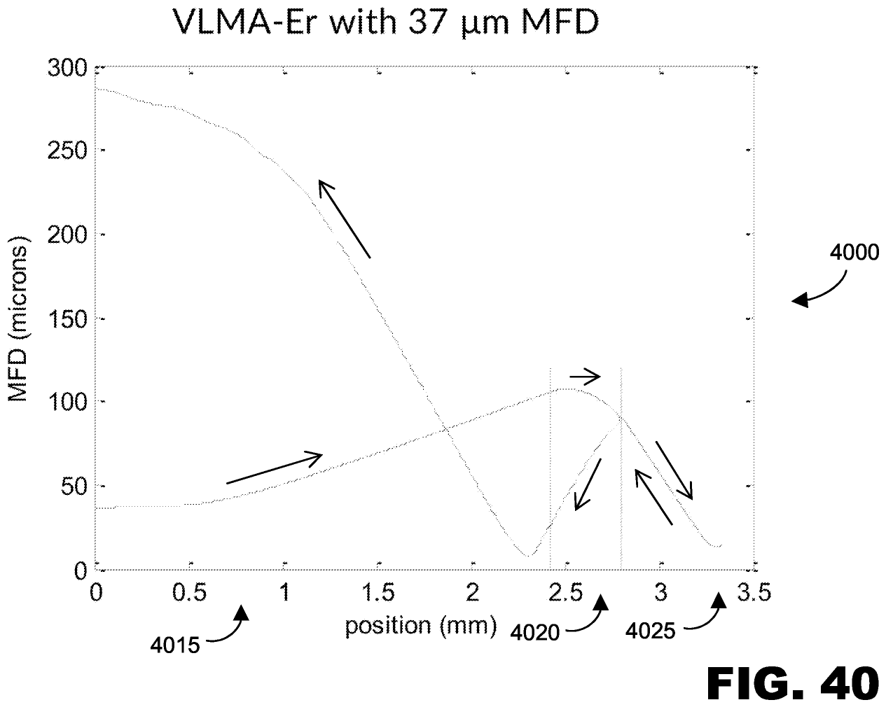

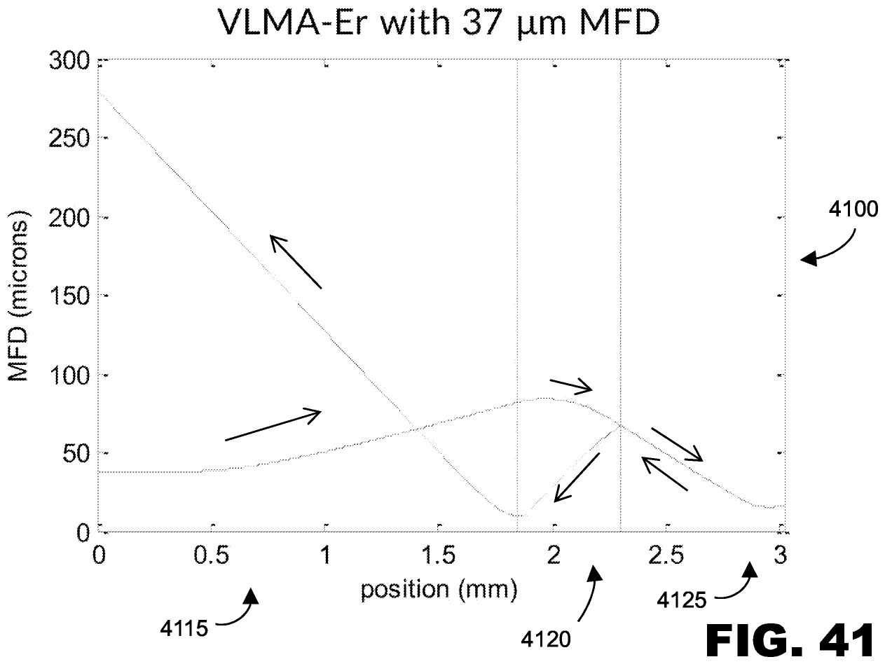

FIGS. 40 and 41 demonstrate why a coreless fiber is needed for very large mode area (VLMA) Erbium (Er) doped fibers (EDF) at 1550 nm. Specifically, FIGS. 40 and 41 show both forward and backward behavior of MFD (μm) for a VLMA-EDF in a GRIN fiber region 4015, 4115 a HF region 4020, 4120 and a HCF region 4025, 4125. As shown in FIGS. 40 and 41, the fundamental mode for VLMA-EDF is too large and, thus, requires a coreless fiber to achieve acceptable coupling loss into the HCF and, also, acceptable return loss into the SCF. In the embodiment of FIG. 40, the simulation parameters are:
λ of ˜1550 nm;
g of ˜1920 m⁻¹;
cordless fiber length of ˜2.42 mm;
GRIN fiber length of ˜0.385 mm; and
hollow fiber length of ˜0.53 mm,
   which results in:
coupling loss into the HCF of ˜0.18 dB; and
return loss into the SCF of ˜30 dB (including a four percent (4%) reflection from the glass-air interface).

In the embodiment of FIG. 41, the simulation parameters are:
λ of ˜1550 nm;
g of ˜1920 m⁻¹; and
cordless fiber length of ˜1.847 mm;
GRIN fiber length of ˜0.455 mm;
hollow fiber length of ˜0.717 mm; and
hollow fiber ID of ˜45 μm,
   which results in:
coupling loss into the HCF of ˜0.23 dB; and
return loss into the SCF of ˜27.5 dB (including 4% reflection from the glass-air interface).

As shown in FIGS. 40 and 41, including the coreless fiber produces acceptable coupling losses and acceptable return losses for VLMA-EDF.

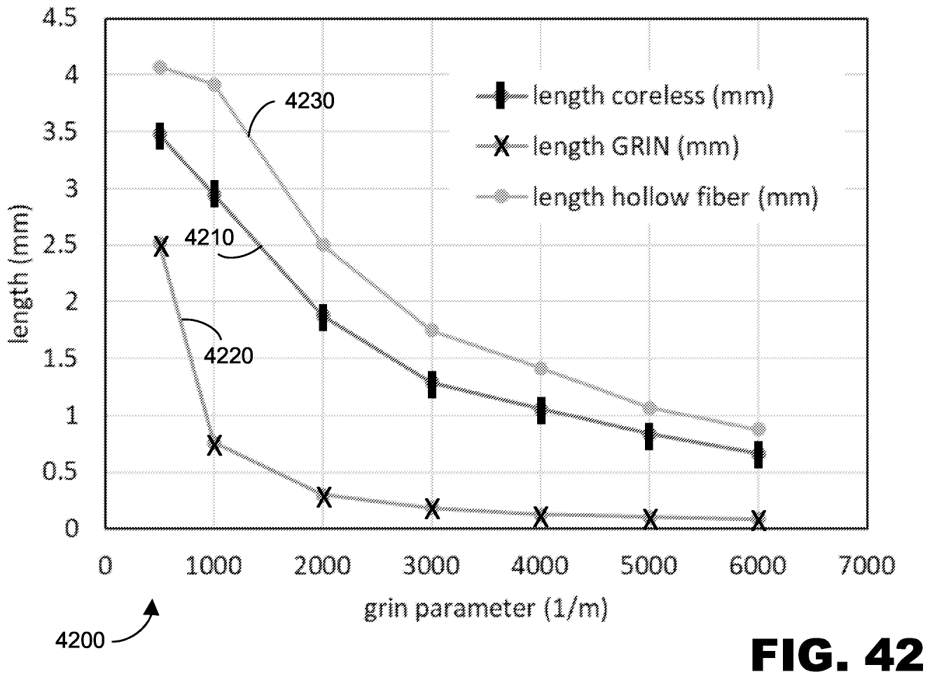

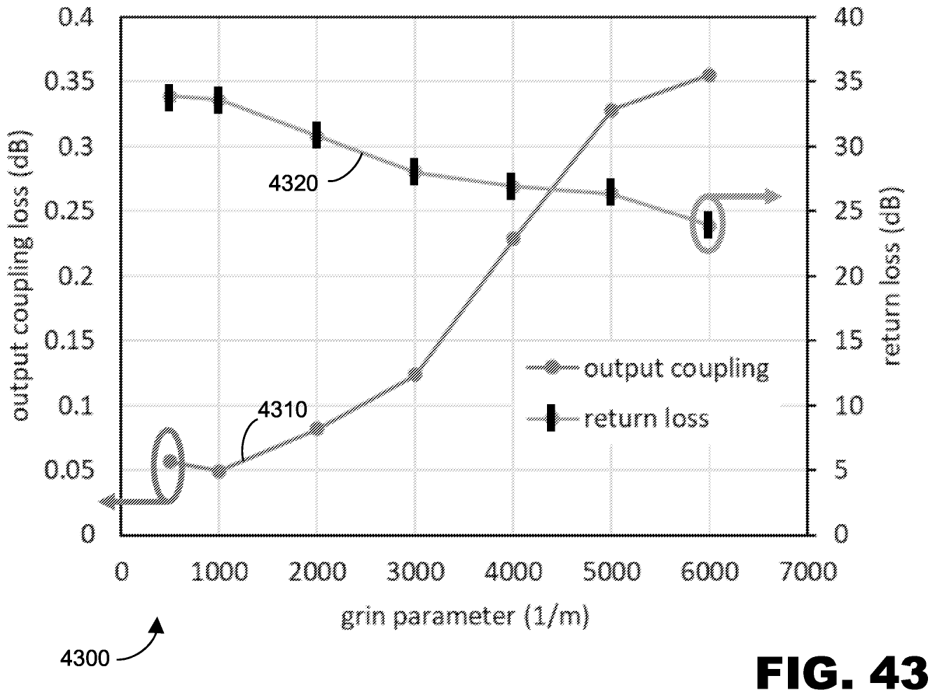

FIGS. 42 and 43 provide an example simulation for operation at λ of ˜1070 nm with a ˜22 μm-core, low NA input fiber. The simulation uses SCF for both input and output and additional parameters of:
input MFD of ˜20 μm;
output MFD of ˜16.7 μm;
GRIN Δn of ˜0.015;
HF IR of ˜100 μm; and
fiber OD of ˜400 μm.

In the graph 4200 of FIG. 42, length (mm) is plotted along Y and GRIN parameter (1/m) is plotted along X for a coreless fiber 4210, a GRIN fiber 4220, and a HF 4230; for the graph 4300 of FIG. 43, output coupling loss 4310 is compared to return loss 4320, with loss (dB) shown along Y and GRIN parameter (1/m) shown along X.

What is shown from FIGS. 42 and 43 is that an acceptable range of g for an optimal design is between ˜1000 m⁻¹ and ˜2000 m⁻¹ where the output coupling loss is low and the return loss is high. Also, for high power lasers at λ of ˜1 μm (or, more precisely, ˜1070 nm), a ˜400 μm-OD fiber provides a large aperture and, thus, a HF with IR of ˜100 μm is sufficient to obtain both acceptable output coupling loss and acceptable return loss values. Also demonstrated by FIGS. 42 and 43 is that GRIN core size limits performance for large g.

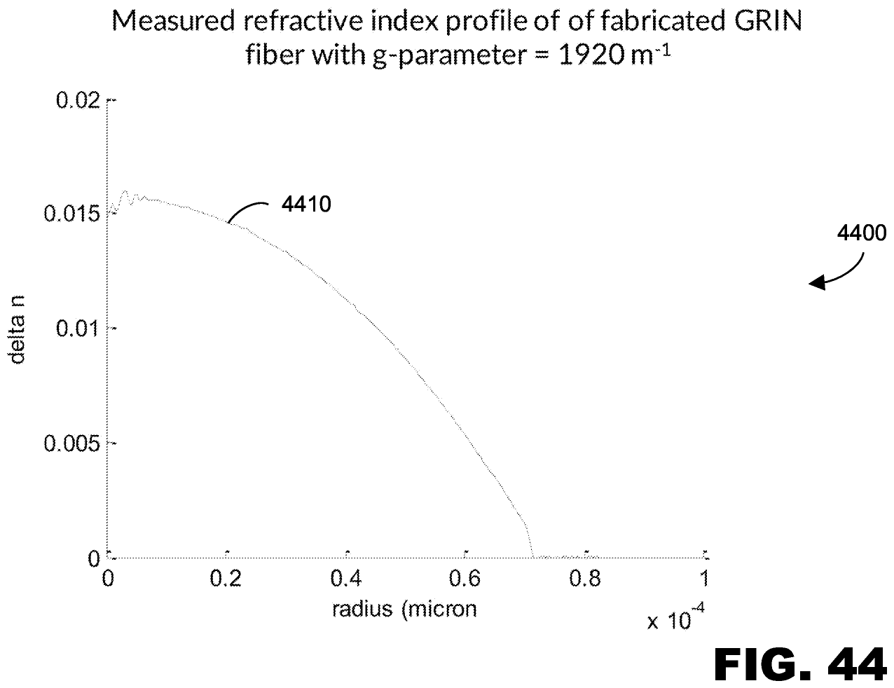

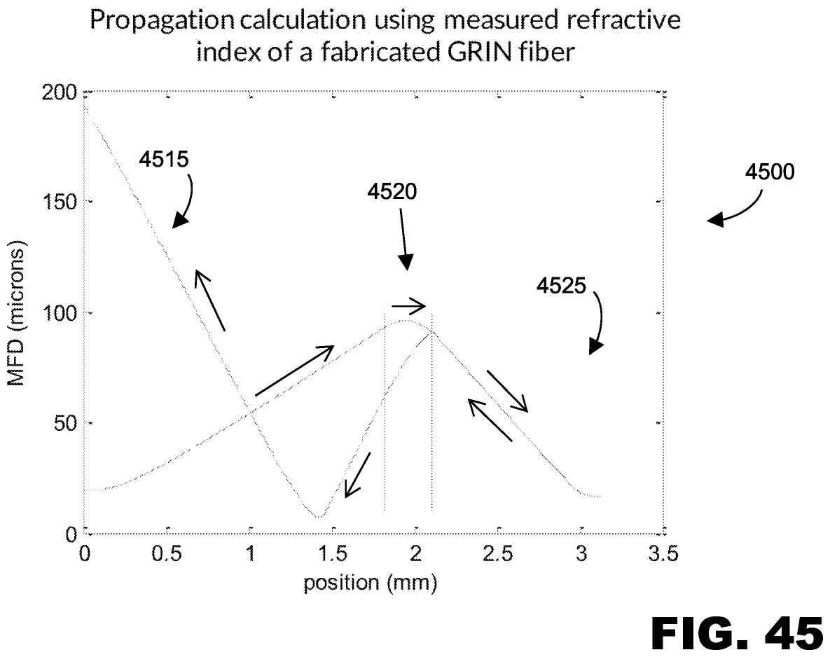

FIG. 44 is a graph 4400 showing a measured refractive index profile 4410 for a GRIN fiber, with Δn along Y and radius (μm) along X, while FIG. 45 is a diagram 4500 showing both forward and backward behavior of MFD (μm) for the GRIN fiber of FIG. 44 in a GRIN fiber region 4115, a HF region 4120, and a HCF region 4125. Specifically, simulation parameters for FIGS. 44 and 45 include:
A of ˜1060 nm;
g of ˜1920 m⁻¹; and
coreless fiber length of ˜1.82 mm;
GRIN fiber length of ˜0.385 mm; and
hollow fiber length of ˜1.02 mm,
   which results in:
coupling loss into the HCF of ˜0.09 dB; and
return loss into the SCF of ˜28.5 dB.

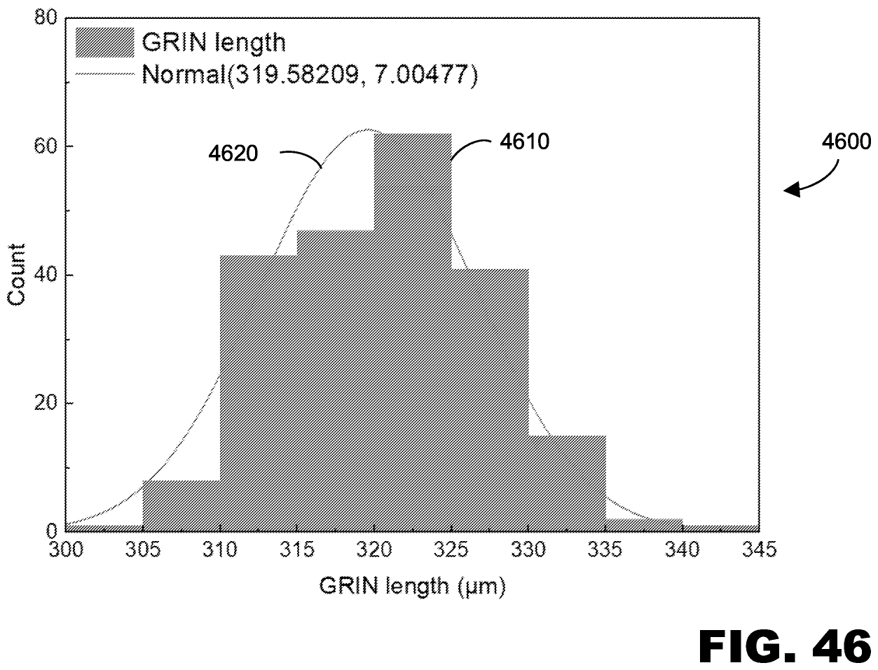

From the measured index profile of FIG. 44 and the propagation calculation of FIG. 45, one can see that precision fabrication of the GRIN permits a suitable structure that can produce both low coupling loss (e.g., ˜0.09 dB) and high return loss (e.g., ˜28.5 dB). The degree of precision of length for GRIN lens fabrication is demonstrated from the data of FIG. 46, which is a graph 4600 showing variations in measured GRIN lengths 4610, with a standard deviation (SD) curve 4620 fit to the measured GRIN lengths 4610. The standard deviation, as shown in FIG. 46, is ˜7 μm for a mean GRIN length of ˜320 μm (measured for 220 fabricated GRIN lenses).

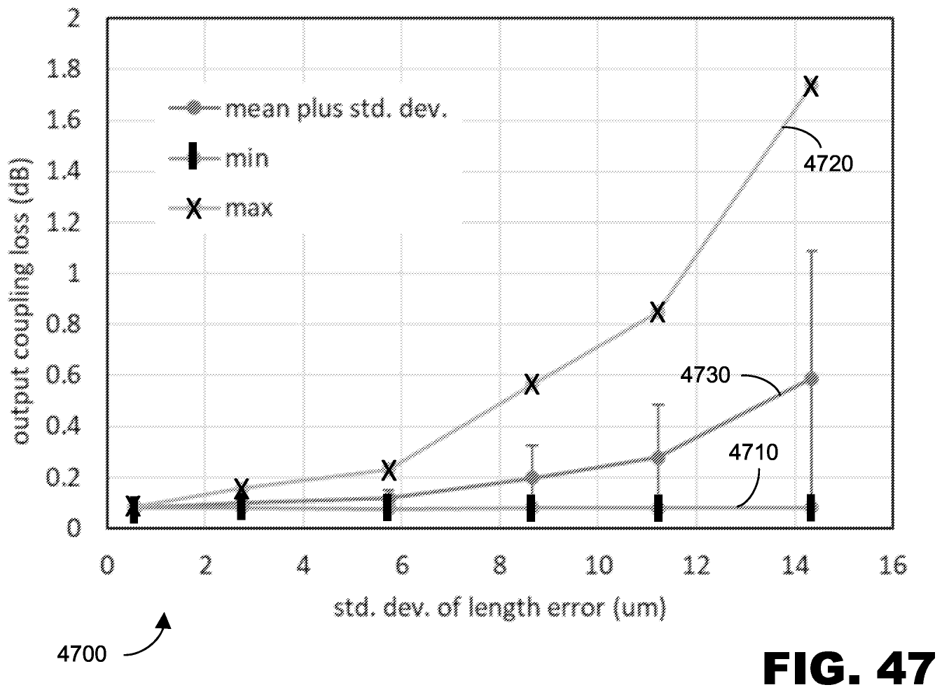

Based on the standard deviation of ˜7 μm, sensitivity to deviation was simulated. The results of the sensitivity calculations are shown in FIGS. 47 through 50.

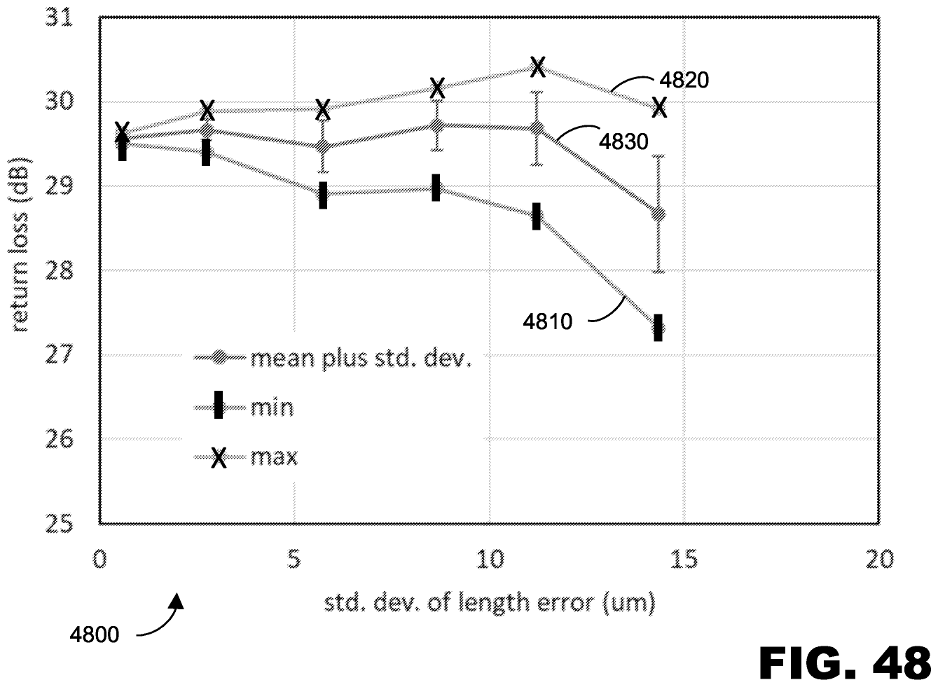

Specifically, FIG. 47 is graph 4700 showing sensitivity of output coupling loss (dB) as a function of SD of length error (μm) for an embodiment of the system with a coreless fiber. FIG. 47 shows minimum output coupling loss 4710, maximum output coupling loss 4720, and mean-plus-SD 4730 of the output coupling loss. FIG. 48 is graph 4800 showing sensitivity of return loss (dB) as a function of SD of length error (μm) for a coreless fiber. FIG. 48 shows minimum return loss 4810, maximum return loss 4820, and mean-plus-SD 4830 of the return loss.

For both FIGS. 47 and 48, the design parameters included:
coreless fiber length of ˜0.3 mm;
GRIN length of ˜2.505 mm;
HF length of ˜0.981 mm;
g of ˜2000 m⁻¹;
λ of ˜1070 nm; and
100 simulations where all fiber lengths varied from optimal length to maximum measured deviations.

The data of FIG. 48 shows that return loss (or input coupling loss) is ˜29.6 dB and is largely insensitive to length variations. However, the output coupling loss (˜0.082 dB) exhibits a deviation of ˜0.7 dB and a mean of ˜0.15 dB (for a length deviation of ˜7 μm).

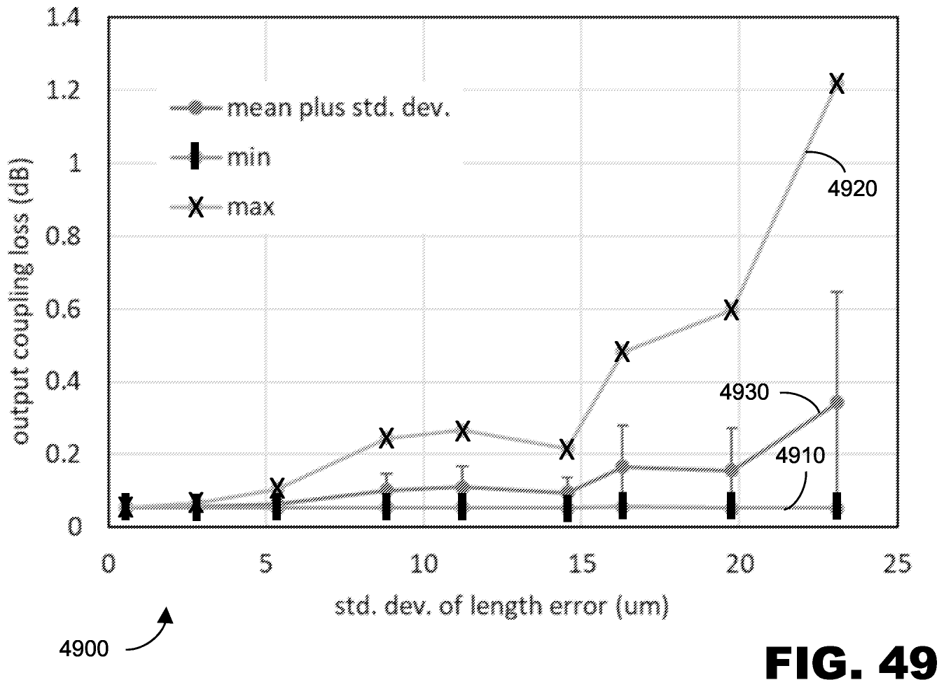

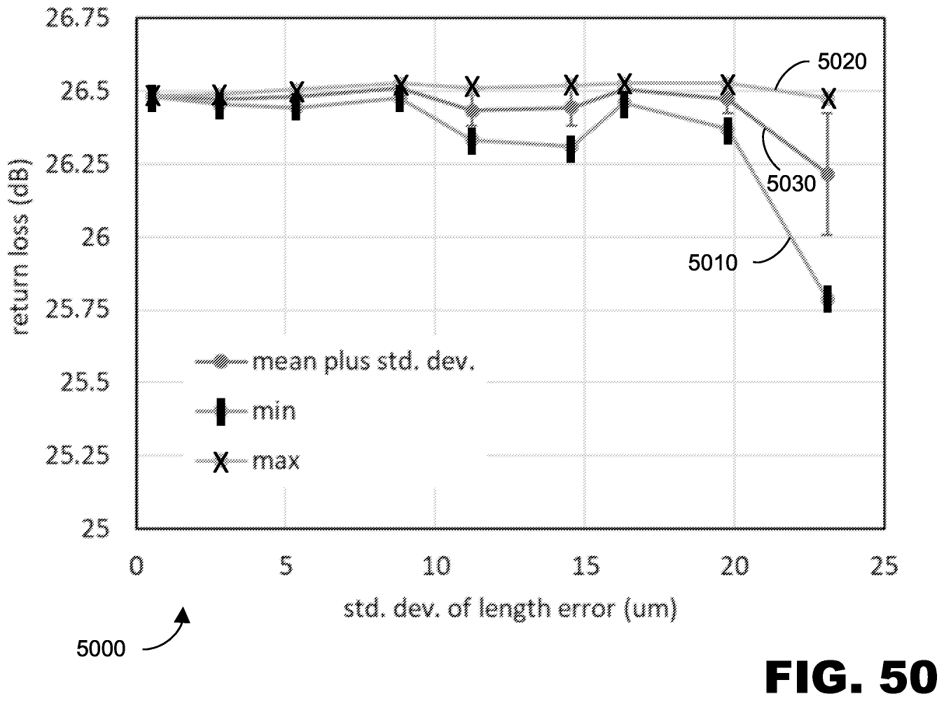

FIG. 49 is graph 4900 showing sensitivity of output coupling loss (dB) as a function of SD of length error (μm) for a system without a coreless fiber. FIG. 49 shows minimum output coupling loss 4910, maximum output coupling loss 4920, and mean-plus-SD 4930 of the output coupling loss. FIG. 50 is graph 5000 showing sensitivity of return loss (dB) as a function of SD of length error (μm) for a system without a coreless fiber. FIG. 50 shows minimum return loss 5010, maximum return loss 5020, and mean-plus-SD 5030 of the return loss.

For both FIGS. 49 and 50, the design parameters included:
input MFD of ˜10 μm;
output MFD of ˜16.7 μm;
input and output fibers being SCF for the simulation;
GRIN length of ˜1.15 mm;
HF ID of ˜45 μm;
HF length of ˜0.585 mm;
g of ˜2000 m⁻¹;
GRIN Δn of ˜0.015;
λ of ˜1550 nm; and
fiber OD of ˜125 μm.

The system of FIGS. 49 and 50 (without the coreless fiber) is less susceptible to length variations than the system with the coreless fiber (in FIGS. 47 and 48). This reduced susceptibility is likely due to less stack-up error in length (because there is one fewer component). The data of FIGS. 49 and 50 show a SD in length error of ˜12 μm to ˜15 μm, which is tolerable, insofar as the experimental SD in length was ˜7 μm (as seen from FIG. 46).

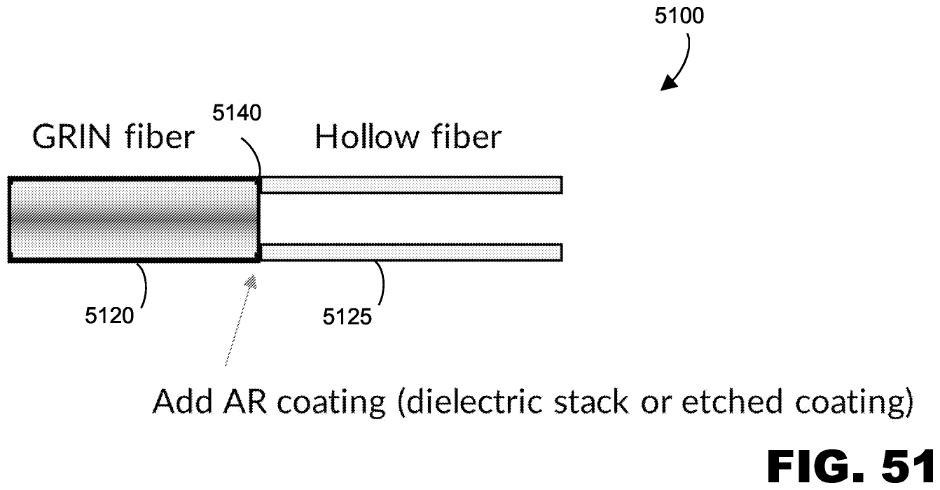

For high-power lasers, it may be necessary to have a return loss that is greater than ˜30 dB. To achieve higher return loss, an anti-reflective coating can be applied between a GRIN fiber 5120 and a HF 5125, as shown in FIG. 51. Possible processes for applying such an anti-reflective coating include adding the anti-reflective coating to the GRIN surface prior to splicing the GRIN with the HF, or possibly adding the anti-reflective coating through the hollow void of the HF, or etching the anti-reflective coating via the hollow void of the HF.

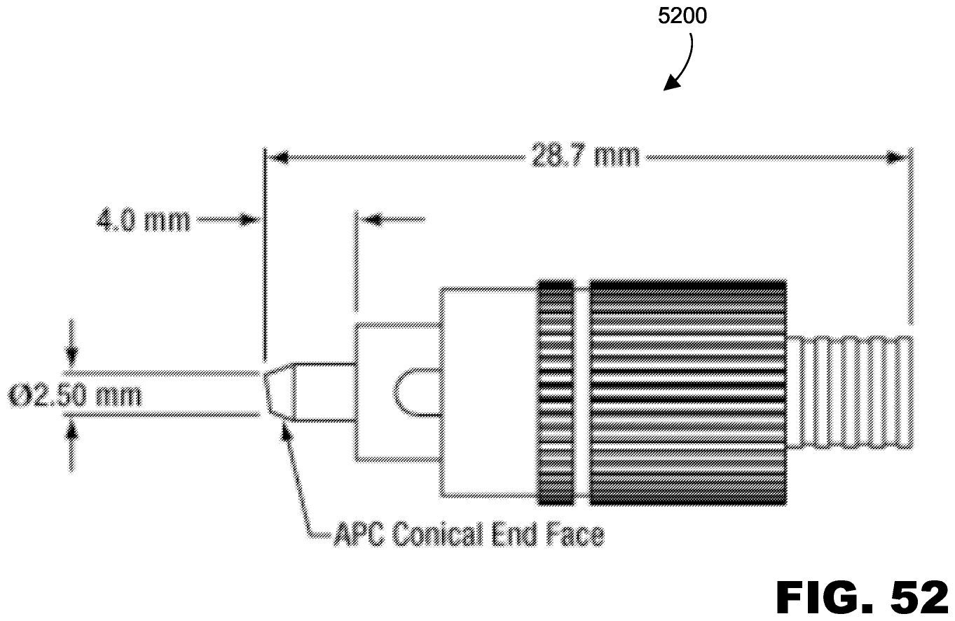

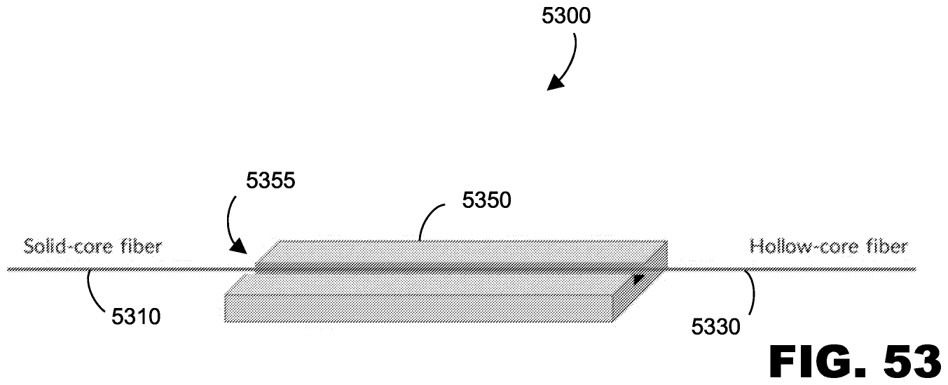

FIG. 52 shows a connector 5200 in accordance with one embodiment of the invention, which is capable of implementing a SMF-to-HCF connection; FIG. 53 shows one embodiment of a packaging system 5300 with a baseplate 5350 with a groove 5355 that holds a SCF 5310 and a HCF 5330 designed for use when end-terminating a high-power fiber laser with hollow-core fiber.

By way of example, for embodiments without the coreless fiber (such as that shown in FIG. 24 or FIG. 51), the SCF-to-HCF interface can be packaged into the connector 5200 with angled physical contact (APC), or other type of FC/PC or FC/APC connector, which provides a connectorized HCF that mates to a SMF with low return loss. At λ of ˜1550 nm, the combined length of the GRIN fiber and the SMF fiber is less than ˜2 mm, thereby making such a connector 5200 convenient for packaging the SCF-to-HCF system. For such a connectorized embodiment, a connector barrel is designed to closely match the HF OD to keep the HF substantially straight and immobilized.

Because the entire combined length of the coreless fiber, GRIN fiber, and the HF can be less than approximately one centimeter (˜1 cm), the desired optical assembly can be placed in a groove 5355 of a baseplate 5350 (such as that shown in FIG. 53) and assembled using known processes, which are not discussed further herein. When operating a fiber laser with high power the groove can be filled with a thermal interface material to control the temperature of the SCF to HCF optical assembly.

As shown and described above, with reference to FIGS. 1 through 53, the present disclosure teaches all-fiber systems and methods for optically coupling a solid-core fiber (SCF) with a hollow-core fiber (HCF) without additional mechanical connectors.

Some embodiments, such as that shown in FIG. 24, use a combination of GRIN fiber with a HF. For these embodiments, the GRIN fiber and HF reside between the SCF and the HCF and provide an optical pathway between the SCF with the HCF. The combination of the GRIN fiber with the HF permits mode matching between the SCF and the HCF, while concurrently increasing return loss from the HCF to the SCF. More specifically, the system optically couples an output end of the SCF (which has a SCF core diameter) with an input end of the HCF (which has a HCF core diameter). That optical coupling system comprises the HF, which has a HF ID, a HF input end, a HF output end that is optically coupled to the HCF input end, and a HF length in which a signal propagating from the HF input end to the HF output end evolves from a HF input MFD to a HF output MFD. The HF output MFD is smaller than the HF input MFD and, eventually, the HF output MFD matches the HCF MFD. The optical coupling system further comprises a GRIN fiber, with a glass-air interface located at the HF input end (where the HF interfaces the GRIN fiber). The GRIN fiber comprises a GRIN input end that is optically coupled to the SCF output end. The GRIN fiber further comprises a GRIN output end that is optically coupled to the HF input end (at the location of the glass-air interface). The GRIN fiber also comprises a GRIN length, a GRIN index profile, and a GRIN parameter (g), all of which (in combination with the HF ID) ensures that the HF output MFD matches the HCF core diameter. The signal propagating forward through the GRIN length evolves from a GRIN input MFD to a GRIN output MFD in such a way that the signal propagating forward partially exits the GRIN output end and enters the HF input end. That partially exiting signal has a GRIN output MFD that is decreasing as it exits the GRIN output end and enters the HF input end, thereby becoming further focused in the HF and eventually becoming mode-matched as it enters the HCF, which results in low output loss or a low coupling loss in the forward-propagating direction. Also, the signal is partially reflected back into the GRIN fiber by the glass-air interface, with the partially reflected signal propagating backward through the GRIN and exiting at the GRIN input end. That partially reflected signal has a reflected MFD at the GRIN input that is larger than the SCF core diameter, thereby resulting in a large return loss. Again, the combination of the g, the GRIN index profile, the GRIN length, and the HF ID ensures that the partially reflected MFD does not match the SCF core diameter, thereby ensuring the high return loss.

Other embodiments, such as that shown in FIG. 4, use an additional coreless fiber that resides between the SCF and the GRIN fiber. For these embodiments, the system optically couples an output end of the SCF (having a SCF core diameter) with an input end of the HCF (having a HCF core diameter). The optical coupling system comprises the coreless fiber, which has a coreless fiber input end and a coreless fiber output end. The coreless fiber input end is optically coupled to the SCF output end. The optical coupling system further comprises a HF having a HF ID, a HF input end, a HF output end (which is optically coupled to the HCF input end, and a HF length. A signal (e.g., an optical signal having a center wavelength (λ) at approximately 1550 nanometers (˜1550 nm)) propagating from the HF input end to the HF output end evolves from a HF input MFD to a HF output MFD, with the HF output MFD being smaller than the HF input MFD and, ultimately, the HF output MFD matching the HCF core diameter when the signal reaches the HCF. The optical coupling system further comprises a GRIN fiber, with a glass-air interface located at the HF input end (at the interface between the GRIN fiber and the HF fiber). The GRIN fiber comprises a GRIN input end optically coupled to the coreless fiber output end and a GRIN output end optically coupled to the HF input end (at the location of the glass-air interface). The GRIN fiber further comprises a GRIN length, such that a signal propagating forward through the GRIN length evolves from a GRIN input MFD to a GRIN output MFD. Ultimately, the signal propagating forward partially exits the GRIN output end and enters the HF input end, with the partially exiting signal having a GRIN output MFD that is decreasing as it exits the GRIN output end and enters the HF input end. The signal is partially reflected back into the GRIN fiber by the glass-air interface, with the partially reflected signal propagating backward through the GRIN. The backward-propagating signal exits the GRIN input end and enters the coreless fiber output end. The backward-propagating signal propagates through the coreless fiber length to the coreless fiber input end. The backward-propagating signal has a reflected MFD at the coreless fiber input end, with the reflected MFD at the coreless fiber input end being larger than the SCF core diameter. The GRIN fiber further comprises a GRIN index profile and a GRIN parameter (g). The combination of the GRIN index profile, the g, the GRIN length, and the HF ID are designed to ensure that both: (a) the HF output MFD matches the HCF core diameter (thereby ensuring a low output loss or a low coupling loss in the forward-propagating direction); and (b) the reflected MFD at the coreless fiber input is larger than the SCF core diameter (thereby ensuring a high return loss).

Ultimately, the preferred embodiment is an all-fiber system that comprises a low coupling loss (preferably less than ˜2 dB, more preferably less than ˜1 dB, and even more preferably less than ˜0.5 dB) and a high return loss (preferably greater than ˜27 dB, more preferably greater than ˜29 dB, even more preferably greater than ˜30 dB).

Any process descriptions or blocks in flow charts should be understood as steps in the process, and alternate implementations are included within the scope of the preferred embodiment of the present disclosure in which functions may be performed out of order from that shown or discussed, including substantially concurrently or in reverse order, depending on the functionality involved, as would be understood by those reasonably skilled in the art of the present disclosure.

It should also be understood that the SCF disclosed herein are, for some embodiments, single-mode optical fibers (SMF) that comply with industry standards, such as the International Telecommunications Union, Telecommunications (ITU-T) Standards. For some embodiments, the optical fibers comply with the ITU-T G.652 standard, ITU-T G.655 standard, ITU-T G.651 standard, ITU-T G.652 standard, ITU-T G.654 standard, or any other known standard that is well known to those having ordinary skill in the art and accepted in the industry.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A system for optically coupling an output end of a solid-core fiber (SCF) with an input end of a hollow-core fiber (HCF), the system comprising:
a graded-index (GRIN) fiber located between the SCF and the HCF; and
a physical separation between the GRIN fiber and the HCF.

2. The system of claim 1, wherein the physical separation comprises a hollow fiber (HF).

3. The system of claim 1, further comprising a coreless fiber located between the SCF and the GRIN.

4. The system of claim 1, further comprising a connector that houses the GRIN fiber and the physical separation.

5. The system of claim 1, comprising:
a coupling loss that is less than approximately two decibels (<˜2 dB); and
a return loss that is greater than approximately twenty-seven decibels (>˜27 dB).

6. A system for optically coupling an output end of a solid-core fiber (SCF) with an input end of a hollow-core fiber (HCF), the system comprising:
a coreless fiber comprising:
a coreless fiber input end optically coupled to the SCF output end; and
a coreless fiber output end;
a hollow fiber (HF) comprising:
a HF input end;
a HF output end optically coupled to the HCF input end;
a glass-air interface located at the HF input end; and
a graded-index (GRIN) fiber comprising:
a GRIN input end optically coupled to the coreless fiber output end;
a GRIN output end optically coupled to the HF input end at the location of the glass-air interface.

7. The system of claim 6, further comprising an anti-reflective coating at the glass-air interface.

8. The system of claim 6, further comprising a fusion splice that optically couples the coreless fiber input end to the SCF output end.

9. The system of claim 6, further comprising a fusion splice that optically couples the HF output end to the HCF input end.

10. The system of claim 6, further comprising a fusion splice that optically couples the GRIN input end to the coreless fiber output end.

11. The system of claim 6, further comprising a fusion splice that optically couples the GRIN output end to the HF fiber input end.

12. The system of claim 6, further comprising a connector that houses the coreless fiber, the GRIN, and the HF.

13. The system of claim 6, further comprising a connector that houses the SCF, the coreless fiber, the GRIN, and the HF.

14. The system of claim 6, comprising:
a coupling loss that is less than approximately two decibels (<˜2 dB); and
a return loss that is greater than approximately twenty-seven decibels (>˜27 dB).

15. A system for optically coupling an output end of a solid-core fiber (SCF) with an input end of a hollow-core fiber (HCF), the system comprising:
a hollow fiber (HF) comprising:
a HF input end;
a HF output end optically coupled to the HCF input end;
a glass-air interface located at the HF input end; and
a graded-index (GRIN) fiber comprising:
a GRIN input end optically coupled to the SCF output end; and
a GRIN output end optically coupled to the HF input end at the location of the glass-air interface.

16. The system of claim 15, further comprising an anti-reflective coating at the glass-air interface.

17. The system of claim 15, further comprising a fusion splice that optically couples the HF output end to the HCF input end.

18. The system of claim 15, further comprising a fusion splice that optically couples the GRIN output end to the HF fiber input end.

19. The system of claim 15, further comprising a connector that houses the GRIN and the HF.

20. The system of claim 15, comprising:
a coupling loss that is less than approximately two decibels (<˜2 dB); and
a return loss that is greater than approximately twenty-seven decibels (>˜27 dB).
